(19) United States
(12) Patent Application Publication
(10) Pub. No.: US 2020/0396054 A1
(43) Pub. Date: Dec. 17, 2020

(54) Secure Memory Read

(71) Applicant: Macronix International Co., Ltd., Hsinchu (TW)

(72) Inventors: Sheng-Lun WU, Toufen City (TW); Chun-Lien SU, Taichung (TW)

(73) Assignee: Macronix International Co., Ltd., Hsinchu (TW)

(21) Appl. No.: 16/442,722

(22) Filed: Jun. 17, 2019

(51) Int. Cl. H04L 9/06; G06F 21/60; H04L 9/32; G06F 3/06

(52) U.S. Cl. CPC H04L 9/0618; G06F 21/602; G06F 3/0673; G06F 3/0623; G06F 3/064; H04L 9/3247

(57) ABSTRACT

A host device receives, from a memory device, secure data that includes a first content block and a second content block. Upon determining that the first content block is encrypted, the host device decrypts the first content block to obtain corresponding first plaintext data. Upon determining that the second content block is unencrypted, the host device obtains corresponding second plaintext data from the second content block. When the reception of secure data from the memory device is completed, the host device obtains a first signature from a signature block sent along with the secure data. The host device computes a second signature on the plaintext data obtained by the host device, and compares the first signature to the second signature. If the host device determines that the first signature is equal to the second signature, then the host device accepts the plaintext data as legitimate.

### TECHNICAL FIELD

The following disclosure relates generally to secure memory, and in particular, to methods, apparatus and systems related to secure read operations on a memory device.

### BACKGROUND

A memory device includes storage memory, e.g., flash memory, and a memory controller that manages the storage memory. The memory controller receives commands from a host device to perform memory operations, such as writing content to the storage memory or reading content from the storage memory.

### SUMMARY

The present disclosure describes methods, apparatus and systems to perform secure read operations on a memory device, such as reading content from the memory device in a cryptographically secure manner, e.g., using encryption, or authentication with digital signatures, or both. The memory device includes storage memory for storing data and a memory controller for managing access to the storage memory by a host device that is coupled to the memory device. Upon receiving a read command from the host device, the memory controller retrieves the requested content from the storage memory and performs cryptographic operations on the plaintext content before sending a secured version of the content to the host device. In some implementations, the memory controller performs cryptographic operations on the plaintext content in units of sections, where each section includes one or more blocks of plaintext content. As part of the cryptographic operations, the memory controller computes a digital signature on the blocks of plaintext content across one or more sections. The memory controller also encrypts the plaintext content in a subset of the content blocks using a suitable encryption mechanism or algorithm to generate ciphertext content for these blocks, while leaving content in the remaining content blocks in plaintext form. In some implementations, the memory controller combines a nonce (e.g., a random number) with the plaintext content before encryption, where the nonce is updated in synchronization with the host device. In some implementations, the memory controller uses a plurality of encryption mechanisms, e.g., by encrypting some of the content blocks using a first encryption algorithm while encrypting some other content blocks using a different second encryption algorithm. Following the cryptographic operations, the memory controller sends the secured content to the host device, where the secured content includes the digital signature and, in each of one or more sections, one or more blocks of encrypted ciphertext data or one or more blocks of unencrypted plaintext data, or both.

In this context, a section of content refers to a known portion of the requested content, e.g., code or data, which is sent from the memory device to the host device. The total content is made of up one or more sections. A content block refers to a portion of content within a section, such that a section includes one or more content blocks. For example, in some implementations, a section of content is 512 bytes in size, while a content block is 32 bytes. Accordingly, in such implementations, a section includes 16 content blocks. If the requested content is 1 megabyte in total size, then the requested content includes 2000 sections of 512 bytes each, with each section having 16 content blocks (there being total 32000 content blocks of the requested content). As another example, in some other implementations, a section of content is 1 kilobyte in size, while a content block is 128 bytes. Accordingly, in such implementations, a section includes 8 content blocks. For requested content of size 1 megabyte, the requested content includes 1000 sections of 1 kilobyte each, with each section having 8 content blocks, there being total 8000 content blocks of the requested content. In some implementations, the size of a section, or of a content block within a section, or both, are determined and known to the host device and the memory device prior to exchange of secured content. In some implementations, the size of a section, or of a content block within a section, or both, are configurable, e.g., set by a user through a user interface coupled to the host device.

The host device performs complementary operations on the secured content received from the memory device to recover the plaintext content. In some implementations, the host device retrieves and temporarily stores the signature sent by the memory device as part of the secured content. The host device determines, in each section of the received content, the content blocks that are encrypted (e.g., ciphertext) and the content blocks that are unencrypted (e.g., plaintext). For the encrypted content blocks, the host device performs decryption operations to obtain the plaintext from the ciphertext using suitable decryption mechanisms, e.g., decryption algorithms corresponding to the encryption algorithms used on the respective content blocks. When the host device determines that all encrypted content blocks have been decrypted, the host device computes a signature on the combined plaintext obtained from the encrypted content blocks and the unencrypted content blocks. The host device compares the signature received from the memory device with the computed signature. If the two signatures match, the host device accepts the plaintext as legitimate. If the two signatures do not match, the host device rejects the plaintext as illegitimate or compromised, e.g., having been subject to unauthorized modification. In some implementations, when decrypting a content block, the host device identifies and removes a nonce that was sent by the memory device combined with the plaintext, where the nonce is updated in synchronization with the memory device. In some implementations, the host device uses a plurality of decryption mechanisms, e.g., by decrypting some of the content blocks using a first decryption algorithm while decrypting some other content blocks using a different second decryption algorithm.

In some implementations, the content secured in the manner described above includes code stored in the memory device, e.g., boot code. In some implementations, the content secured in the manner described above includes both boot code and user data (e.g., public or private user data) stored in the memory device.

In a general aspect, a host device receives secure data from a memory device that is coupled to the host device, the secure data including a first content block and a second content block. The host device determines that the first content block is encrypted. Upon determining that the first content block is encrypted, the host device decrypts the first content block to obtain corresponding first plaintext data. The host device determines that the second content block is unencrypted. Upon determining that the second content block is unencrypted, the host device obtains, from the second content block, corresponding second plaintext data. The host device determines whether reception of secure data from the memory device is completed. Upon determining that reception of secure data from the memory device is completed, the host device obtains a first signature from a signature block sent by the memory device in conjunction with the secure data. The host device computes a second signature on plaintext data obtained by the host device, the plaintext data including the first plaintext data and the second plaintext data. The host device compares the first signature to the second signature. Conditioned on determining, by the host device as a result of the comparing, that the first signature is equal to the second signature, the host device accepts the plaintext data as legitimate.

Particular implementations may include one or more of the following features. Conditioned on determining, by the host device as a result of the comparing, that the first signature is not equal to the second signature, the host device may discard the plaintext data as compromised.

The host device may determine that the first content block is encrypted using a first encryption mechanism. Decrypting the first content block may comprise decrypting the first content block using the first encryption mechanism. The host device may receive a third content block of the secure data from the memory device and determine that the third content block is encrypted using a second encryption mechanism that is different from the first encryption mechanism. Upon determining that the third content block is encrypted using the second encryption mechanism, the host device may decrypt the third content block using the second encryption mechanism to obtain third plaintext data, wherein the second signature may be computed on plaintext data that includes the first plaintext data, the second plaintext data and the third plaintext data.

The host device may receive the secure data from the memory device in a plurality of sections that each includes encrypted content blocks and unencrypted content blocks. The host device may include a counter to count a number of content blocks of the secure data that is received. The host device may determine that the first content block is encrypted using the first encryption mechanism by determining that a value of the counter is less than a first threshold value that corresponds to a number of content blocks in a section encrypted using the first encryption mechanism. The host device may determine that the third content block is encrypted using the second encryption mechanism by determining that the value of the counter is greater than the first threshold value but less than a second threshold value that corresponds to a number of content blocks in a section encrypted using the first encryption mechanism and the second encryption mechanism. The host device may determine that the second content block is unencrypted by determining that the value of the counter is greater than the second threshold value but less than a third threshold value that corresponds to a total number of content blocks in a section.

The host device may increment the counter upon determining that reception of secure data from the memory device is not completed. The host device may determine whether the counter is equal to the third threshold value. Conditioned on determining that the counter is equal to the third threshold value, the host device may reset the counter to process a new section of the secure data received from the memory device. Conditioned on determining that the counter is not equal to the third threshold value, the host device may process one or more additional content blocks of the current section, the one or more additional content blocks including at least one of a content block encrypted using the first encryption mechanism, a content block encrypted using the second encryption mechanism, or an unencrypted content block.

One or more of the first threshold value, the second threshold value or the third threshold value may be configurable by a user. One or more of the first threshold value, the second threshold value or the third threshold value may be stored in registers coupled to the memory device.

The secure data received from the memory device may include a plurality of encrypted content blocks and unencrypted content blocks. The host device may receive additional information with the memory device about at least one of a relative arrangement of the encrypted content blocks and unencrypted content blocks in the secure data, the first encryption mechanism, or the second encryption mechanism. The host device may determine that the first content block is encrypted using the first encryption mechanism by analyzing the additional information received from the memory device to determine that at least one of the first content block is encrypted or the first encryption mechanism is used to encrypt the first content block. The host device may determine that the third content block is encrypted using the second encryption mechanism by analyzing the additional information received from the memory device to determine that at least one of the third content block is encrypted or the second encryption mechanism is used to encrypt the third content block. The host device may determine that the second content block is unencrypted by analyzing the additional information received from the memory device to determine that the second content block is unencrypted.

Decrypting the first content block to obtain corresponding first plaintext data may comprise identifying a nonce value included in the first content block upon decrypting the first content block. The host device may remove the nonce value from the decrypted first content block to obtain the first plaintext data. The nonce value may be synchronized between the host device and the memory device.

In another general aspect, a memory device receives a request for data from a host device that is coupled to the memory device. In response to the request, the memory device processes the data for transmission to the host device, wherein the processing comprises: dividing the data into a plurality of sections, each section including one or more content blocks; computing a signature on the content blocks included in the plurality of sections; encrypting, in each section, a subset of the content blocks included in the section; and including, in each section, a remaining number of unencrypted content blocks as plaintext. The memory device sends, to the host device, the plurality of sections along with the signature, each of the plurality of sections including encrypted content blocks and unencrypted content blocks.

Particular implementations may include one or more of the following features. The memory device may include a counter to count a number of content blocks in each section. The memory device may encrypt the subset of the content blocks in each section by determining whether a value of the counter is less than a first threshold value that corresponds to a number of content blocks in a section encrypted using a first encryption mechanism. Upon determining that the value of the counter is less than the first threshold value, the memory device may iteratively encrypt first content blocks of the subset of the content blocks using the first encryption mechanism, and increment the counter.

The memory device may determining whether the value of the counter is less than a second threshold value that corresponds to a number of content blocks in a section encrypted using a second encryption mechanism that is different from the first encryption mechanism. Upon determining that the value of the counter is less than the second threshold value, the memory device may iteratively encrypt second content blocks of the subset of the content blocks using the second encryption mechanism, and increment the counter. The memory device may determine that the value of the counter is equal to a third threshold value that corresponds to a total number of content blocks in a section. Upon determining that the value of the counter is equal to the third threshold value, the memory device may reset the counter and process a next section of the plurality of sections.

The memory device may receive, from the host device, one or more of the first threshold value, the second threshold value or the third threshold value that are configured by a user. The memory device may store one or more of the first threshold value, the second threshold value or the third threshold value in registers coupled to the memory device.

The memory device may encrypt the subset of the content blocks in each section by including, in one or more content blocks of the subset of the content blocks, a nonce value. The memory device may encrypt the subset of the content blocks following including the nonce value in the one or more content blocks of the subset of the content blocks, wherein the nonce value may be synchronized with the host device.

In another general aspect, a memory device comprises a storage memory for storing data and a memory controller for managing access to the storage memory. The memory controller is adapted to receive a request for data from a host device that is coupled to the memory device and in response to the request, process the requested data for transmission to the host device. The memory controller is adapted to process the requested data by: accessing, from the storage memory, the requested data; dividing the requested data into a plurality of sections, each section including one or more content blocks; computing a signature on the content blocks included in the plurality of sections; encrypting, in each section, a subset of the content blocks included in the section; and including, in each section, a remaining number of unencrypted content blocks as plaintext. The memory controller is adapted to send, to the host device, the plurality of sections along with the signature, each of the plurality of sections including encrypted content blocks and unencrypted content blocks.

Particular implementations may include one or more of the following features. The memory controller may include a counter to count a number of content blocks in each section. The memory controller may encrypt the subset of the content blocks in each section by determining whether a value of the counter is less than a first threshold value that corresponds to a number of content blocks in a section encrypted using a first encryption mechanism. Upon determining that the value of the counter is less than the first threshold value, the memory controller may iteratively encrypt first content blocks of the subset of the content blocks using the first encryption mechanism, and increment the counter.

The memory controller may determine whether the value of the counter is less than a second threshold value that corresponds to a number of content blocks in a section encrypted using a second encryption mechanism that is different from the first encryption mechanism. Upon determining that the value of the counter is less than the second threshold value, the memory controller may iteratively encrypt second content blocks of the subset of the content blocks using the second encryption mechanism, and increment the counter. The memory controller may determine that the value of the counter is equal to a third threshold value that corresponds to a total number of content blocks in a section. Upon determining that the value of the counter is equal to the third threshold value, the memory controller may reset the counter and process a next section of the plurality of sections. The memory controller may receive, from the host device, one or more of the first threshold value, the second threshold value or the third threshold value that are configured by a user. The memory controller may store one or more of the first threshold value, the second threshold value or the third threshold value in registers coupled to the memory controller.

The memory controller may encrypt the subset of the content blocks in each section by including, in one or more content blocks of the subset of the content blocks, a nonce value. The memory controller may encrypt the subset of the content blocks following including the nonce value in the one or more content blocks of the subset of the content blocks, wherein the nonce value is synchronized with the host device.

The memory controller may encrypt the subset of the content blocks in each section by selecting one or more first content blocks of the subset and encrypting the one or more first content blocks using a first encryption mechanism. The memory controller may send, to the host device, additional information that includes at least one of location information of the one or more first content blocks, or the first encryption mechanism.

The memory controller may encrypt the subset of the content blocks in each section by selecting one or more first content blocks and one or more second content blocks of the subset. The memory controller may encrypt the one or more first content blocks using a first encryption mechanism, and encrypt the one or more first content blocks using a second encryption mechanism. The memory controller may send, to the host device, additional information that includes at least one of location information of the one or more first content blocks, location information of the one or more second content blocks, the first encryption mechanism or the second encryption mechanism.

Implementations of the above techniques include methods, apparatus, systems and computer program products. One such computer program product is suitably embodied in a non-transitory machine-readable medium that stores instructions executable by one or more processors. The instructions are configured to cause the one or more processors to perform the above-described actions.

Using the novel features described above and in the following sections of this specification, read operations for a memory device can be performed with strong security while maintaining efficiency of the operations. By partially encrypting the content while maintaining in plaintext rest of the content sent from the memory device to the host device, strong security is balanced with efficient performance. In contrast, if all the content is encrypted, as in conventional schemes, then the computational overhead of encryption and decryption, which can be computationally intensive, is high, such that more robust security is achieved at the expense of poorer performance, e.g., significantly longer processing times for encrypting or decrypting the content. The techniques disclosed in this specification makes a trade-off to balance security with performance. This can be advantageous, e.g., when reading content that are important for operation of the host device, such as boot code, or other critical code or data. There are some risks of unauthorized modification during the boot stage, such as forgery (e.g., an adversary duplicates the boot code by probing the input/output (IO) pins of the memory device) or falsification (e.g., an adversary alters the boot code by fixing the I/O level or rewriting the content value in random access memory of the host device). Partially encrypting the boot code using the disclosed techniques prevents forgery or falsification, while maintaining speed of execution at acceptable levels. Encrypting some of the content blocks prevents an eavesdropper on the communication channel (e.g., bus) between the memory device and the host device from being able to forge the entire content, since the eavesdropper cannot determine the plaintext content of the encrypted content blocks from the corresponding ciphertext sent over the communication channel. Using the signature to validate the content prevents an adversary from being able to falsify some of the content.

In some implementations, the security afforded by the disclosed techniques is enhanced by using different encryption schemes for different content blocks. For example, to maintain performance at target levels, a strong cryptographic encryption algorithm, e.g., Digital Encryption Standard (DES), Advanced Encryption Standard (AES), Elliptic Curve Cryptography (ECC) or RC5, is used to encrypt a first subset of content blocks; a simplified cryptographic encryption algorithm, e.g., Exclusive-OR (XOR) or Format-Preserving Encryption (FPE), is used to encrypt a second subset of content blocks; while the remaining content blocks are sent in plaintext. The use of nonce along with encryption helps to prevent replay attacks. In some implementations, a computationally non-intensive algorithm is used for the signature generation/verification, such as Message Digest version 5 (MD5), Secure Hash Algorithm (SHA) or Cyclic Redundancy Check (CRC).

The disclosed techniques can be applied to various types of non-volatile memory devices, such as NAND flash memory or NOR flash memory, universal flash storage (UFS), peripheral component interconnect express (PCIe) storage, or phase-change memory (PCM), among others. Additionally or alternatively, the techniques can be applied to various types of main or cache memory devices, such as static random access memory (SRAM), dynamic random access memory (DRAM), resistive random access memory (ReRAM), or magnetoresistive random-access memory (MRAM), among others. The techniques can also be applied to magnetic disks or optical disks, among others.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an example of a system that performs secure read operations on a memory device.

FIG. 2 illustrates an example of a memory read operation with secured content.

FIGS. 3A-3E illustrate examples of encryption mechanisms for secure content transfer for a read operation.

FIG. 4 illustrates an example of a process to read secured content received from a memory device.

FIG. 5 illustrates an example of a process to synchronize security mechanisms between a host device and a memory device.

FIG. 6 illustrates an example of a process to read secured content received from a memory device.

FIG. 7 illustrates an example of a process to generate secured content for sending to a host device.

Like reference numbers in the figures indicate like elements.

### DETAILED DESCRIPTION

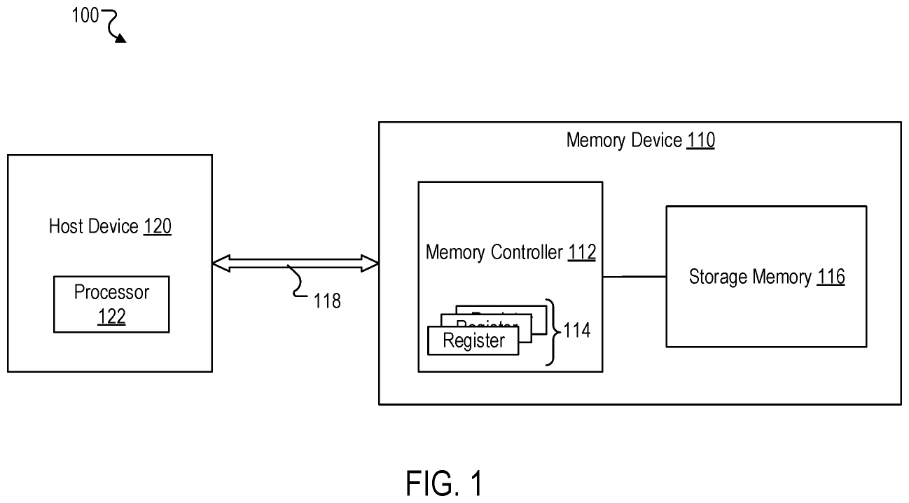

FIG. 1 illustrates an example of a system 100 that performs secure read operations on a memory device 110. The system 100 includes the memory device 110 that is coupled to a host device 120 using a bus 118. The memory device 110 includes a memory controller 112 and a storage memory 116. In some implementations, the memory controller includes one or more registers, which are collectively referred to as registers 114. The host device includes one or more processors, such as processor 122.

In some implementations, the memory device 110 is a storage device. For example, the memory device 110 can be an embedded multimedia card (eMMC), a secure digital (SD) card, a solid-state drive (SSD), or some other suitable storage. In some implementations, the memory device 110 is a client device that is coupled to a host device 120. For example, the memory device 110 can be an SD card that is coupled to a digital camera or a media player as the host device 120.

The memory controller 112 is a general-purpose microprocessor, or an application-specific microcontroller. The memory controller 112 manages access to, and operations performed on, the storage memory 116. The following sections describe the various techniques based on implementations in which the memory controller 112 is used to manage the storage memory 116. However, the techniques described in the following sections are also applicable in implementations in which another type of controller in the memory device 110, different from a memory controller, is used to manage the storage memory.

In some implementations, the storage memory 116 is a non-volatile memory that is configured for long-term storage of instructions and/or data, e.g., a NAND or NOR flash memory, or some other suitable non-volatile memory. In implementations where the storage memory 116 is NAND or NOR flash memory, the memory device 110 is a flash memory device, e.g., a flash memory card, and the memory controller 112 is a flash controller. For illustration purposes, the following description uses a flash memory as an example of the storage memory 116.

The host device 120 sends memory commands to the memory controller 112 using the bus 118 to perform operations on the memory device 110. The memory commands include read, program/write, and erase commands. The read commands are directed towards fetching content stored in the storage memory 116, for use by the host device 120. For example, in some implementations, when the host device 120 powers on, the host device sends a read command to fetch boot code from the storage memory 116. The boot code is executed by the processor 122 to validate peripheral components in the system 100 that are coupled to the host device 120. A read command can also be to fetch other kinds of code or user data stored in the storage memory 116.

As discussed in further detail below, in some implementations, when the host sends a read command to the memory controller 112, the memory controller retrieves the requested content from the respective storage location in the storage memory 116; cryptographically secures the content by encrypting one or more blocks of content, or adding a cryptographic digital signature to the content, or both; and sends the secured content, with one or more encrypted contents blocks and/or the digital signature to the host device 120. The host device decrypts the encrypted content blocks, authenticates the content by checking the digital signature and accepts the unencrypted content if the signature is successfully verified.

In some implementations, the memory controller 112 sends the secured content with a subset of content blocks in each section of the content encrypted while the remaining content blocks in the section unencrypted. In some implementations, the memory controller 112 encrypts different content blocks in the subset of content blocks in a section using different encryption mechanisms, e.g., using one or more strong encryption algorithms and one or more simplified encryption algorithms. In some implementations, the memory controller 112 adds a nonce to a content block before encrypting the content block, where the nonce is changed and synchronized with the host device 120. In some implementations, the nonce is changed periodically. In some implementations, the nonce is changed aperiodically.

In some implementations, the memory controller 112 sends secured content in the manner described above, and in the following sections, when the host device 120 sends a read command for boot code. In some implementations, the memory controller 112 sends secured content when the host device 120 sends a read command to fetch any form of code to be executed by the processor 122. In some implementations, the memory controller 112 sends secured content when the host device 120 sends a read command to fetch either code or user data.

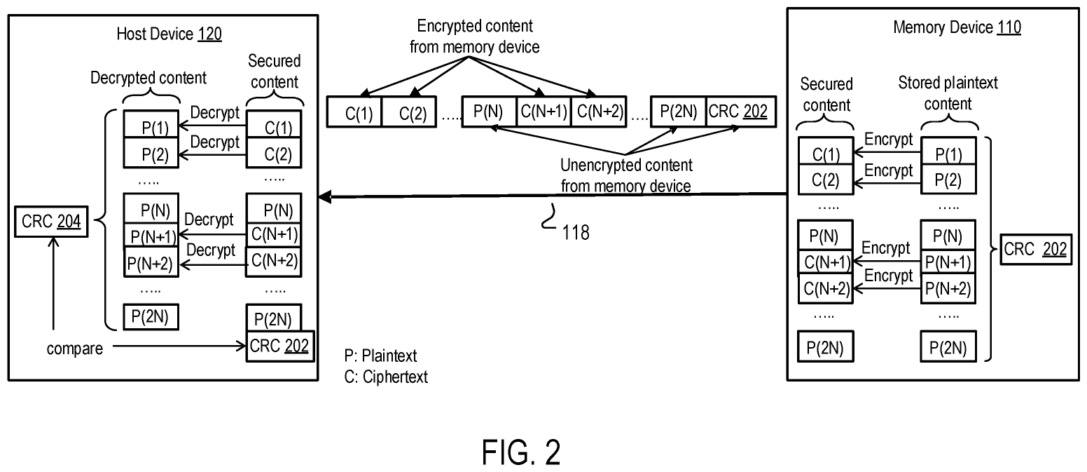

FIG. 2 illustrates an example of a memory read operation with secured content for the devices in the system 100. In some implementations, content is stored in the storage of the memory device 110, e.g., storage memory 116, in unencrypted form, e.g., in plaintext. When the host device 120 sends a read command to the memory device 110, the memory controller of the memory device 110 retrieves the requested plaintext content from the storage memory 116 and performs cryptographic operations on blocks of the plaintext content, e.g., plaintext content blocks P(1), P(2), . . . , P(N), P(N+1), P(N+2), . . . , P(2N).

As part of the cryptographic operations, the memory device 110 (e.g., the memory controller 112) computes a digital signature on the plaintext content blocks P(1), P(2), . . . , P(N), P(N+1), P(N+2), . . . , P(2N). In some implementations, the digital signature is a CRC, e.g., CRC 202 as shown. In some implementations, a different form of digital signature is computed, e.g., MD5 or SHA. In some implementations, a public key-based digital signature is computed, e.g., based on Elliptic Curve Cryptography (ECC).

After computing the digital signature, the memory device 110 performs partial encryption of the content blocks by encrypting a subset of the plaintext content blocks. For example, as shown, the memory device 110 encrypts plaintext content blocks P(1) and P(2) to generate ciphertext content blocks C(1) and C(2), respectively. Similarly, the memory controller 112 encrypts plaintext content blocks P(N+1) and P(N+2) to generate ciphertext content blocks C(N+1) and C(N+2), respectively. In some implementations, the memory device 110 adds a nonce to a plaintext content block before encrypting the content block to generate ciphertext. However, the remaining plaintext content blocks are not encrypted, e.g., plaintext content blocks P(N) and P(2N) are not converted into ciphertext. In this manner, the memory device 110 generates secured content that includes: a number of encrypted content blocks, e.g., ciphertext content blocks C(1), C(2), C(N+1) and C(N+2); a number of unencrypted content blocks, e.g., plaintext content blocks P(N) and P(2N); and a digital signature, e.g., CRC 202. The memory device 110 then sends the secured content to the host device over the bus 118.

The host device 120 receives the secured content from the bus 118, and performs reverse cryptographic operations on the received content to obtain and verify the plaintext content. For example, as shown, the host device 120 (e.g., processor 122) decrypts the received ciphertext content blocks C(1) and C(2) to obtain the corresponding plaintext content blocks P(1) and P(2). Similarly, the host device 120 decrypts the ciphertext content blocks C(N+1) and C(N+2), to obtain the corresponding plaintext content blocks P(N+1) and P(N+2). In some implementations, after decrypting a ciphertext content block, the host device 120 removes a nonce to obtain the plaintext. The content blocks that are received unencrypted, e.g., plaintext content blocks P(N) and P(2N), do not undergo further cryptographic processing.

To decrypt the ciphertext content blocks, the host device 120 uses one or more decryption algorithms that correspond to the encryption algorithms used by the memory controller 112. For example, in some implementations, the memory device 110 uses one of DES, AES, Blowfish, RC5, ECC, or XOR for encryption. Accordingly, the host device 120 also uses one of DES, AES, Blowfish, RC5, ECC or XOR for decryption, respectively. In some implementations, the memory device 110 uses public-key based algorithms. For example, in some implementations, the memory device 110 uses one of RSA or ECC for encryption. Accordingly, the host device 120 also uses one of RSA or ECC for decryption, respectively.

As described further below, the host device 120 and the memory device 110 synchronize the encryption and signature algorithms that are used for consistent operations. In some implementations, the host device 120 and the memory device 110 also synchronizes the cryptographic keys used for encryption, decryption and signature, so that the host device can successfully decrypt the ciphertext content blocks, or verify the digital signature, or both. The synchronizations are performed when the devices are initially coupled, e.g., upon powering on. Additionally or alternatively, the synchronizations are performed at certain time intervals. In some implementations, the host device 120 and the memory device 110 also synchronizes the nonce value—at initial power on, at certain time intervals, or whenever either device changes the nonce value, or any combination of these.

After generating the decrypted content with all plaintext content blocks, the host device 120 computes a digital signature on the plaintext content blocks P(1), P(2), . . . , P(N), P(N+1), P(N+2), . . . , P(2N). The host device 120 uses the same signature algorithm as used by the memory controller 112. E.g., as shown, the host device 120 computes a CRC signature, e.g., CRC 204, on the decrypted plaintext content blocks P(1), P(2), . . . , P(N), P(N+1), P(N+2), . . . , P(2N). The host device 120 then compares the computed signature, e.g., CRC 204, with the signature that is sent by the memory device 110 and obtained from the secured content, e.g., CRC 202.

If the two signature values match, then the host device 120 accepts the plaintext content blocks P(1), P(2), . . . , P(N), P(N+1), P(N+2), . . . , P(2N) as legitimate, e.g., as being true copies of the content sent by the memory device 110, that has not been altered in an unauthorized manner by a third party, e.g., an eavesdropper adversary entity. The host device 120 then processes the content, e.g., the processor 122 executes the boot code. On the other hand, if the two signature values do not match, then the host device 120 rejects the plaintext content blocks P(1), P(2), . . . , P(N), P(N+1), P(N+2), . . . , P(2N) as illegitimate, e.g., as being different from the content stored in the memory device 110, having been forged or falsified by a third party.

In the above manner, the host device 120 and the memory device 110 can provide secure read operations in the system 100. By sending some plaintext content blocks in encrypted form, an adversary who eavesdrop on the bus cannot know and duplicate the content, since the adversary cannot decrypt the ciphertext content blocks without knowledge of the cryptographic algorithm and/or the cryptographic keys (which are known only to the host device and the memory device). By sending a digital signature computed on the plaintext content blocks, an adversary cannot tamper with, e.g., falsify, the content, since the adversary cannot generate a digital signature without knowledge of all the plaintext content blocks. In the above manner, forgery or falsification of the content is prevented.

However, by performing partial encryption on a limited subset of the content blocks, the computational overhead of encryption operations is limited, such that the secure memory read operation can be done much more efficiently (e.g., in less time, or with less energy expenditure by the memory device and the host device, or both) compared to cases where all the content blocks are encrypted.

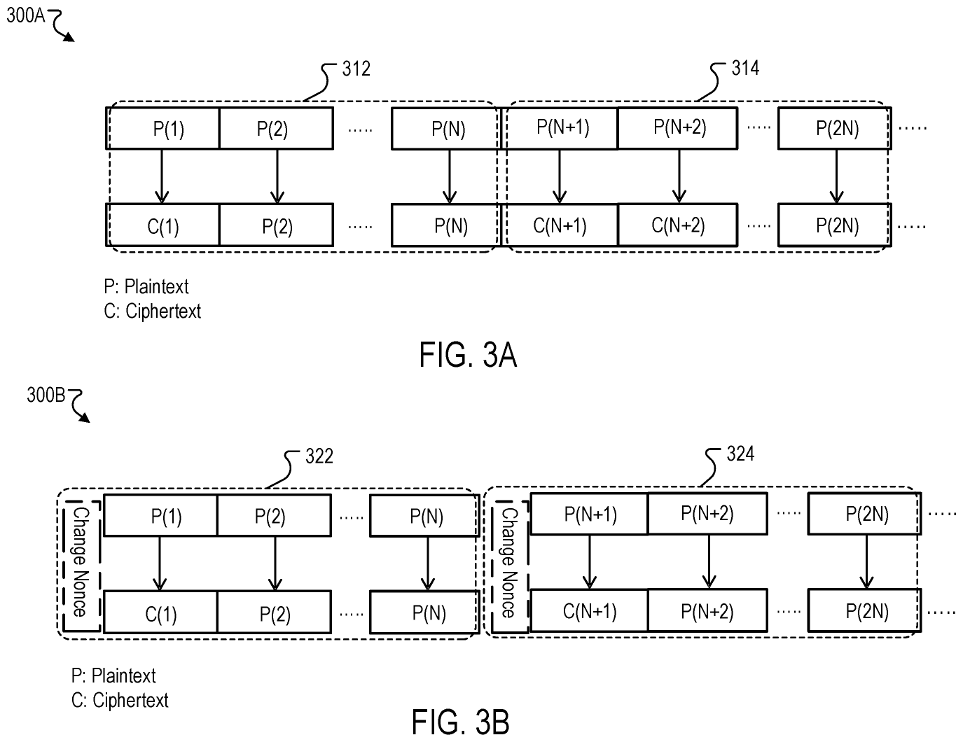

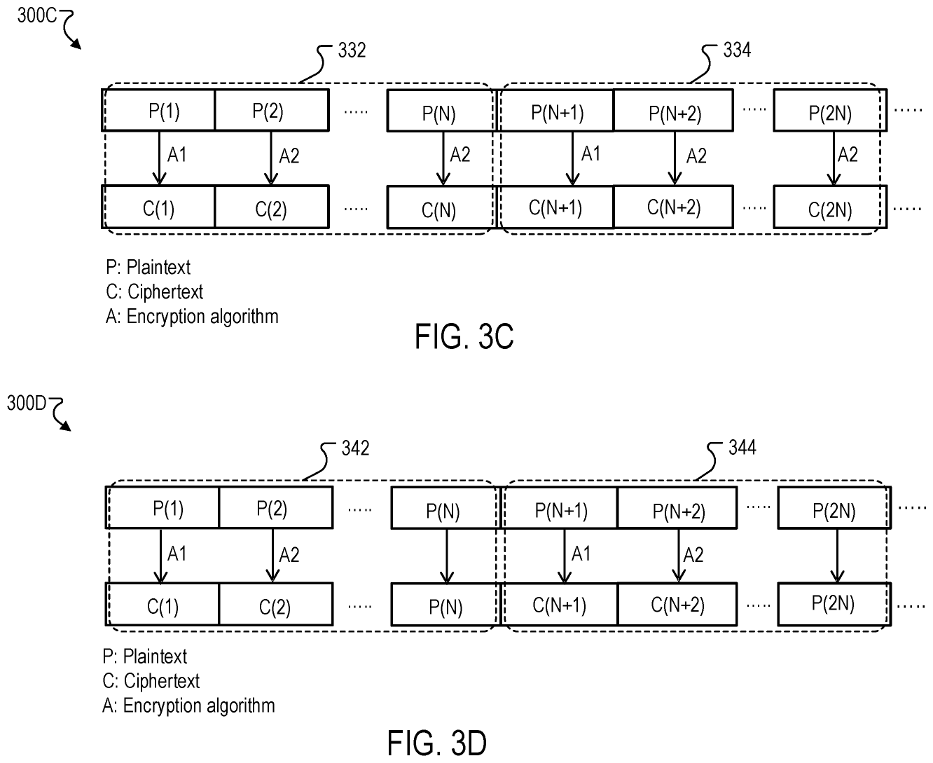

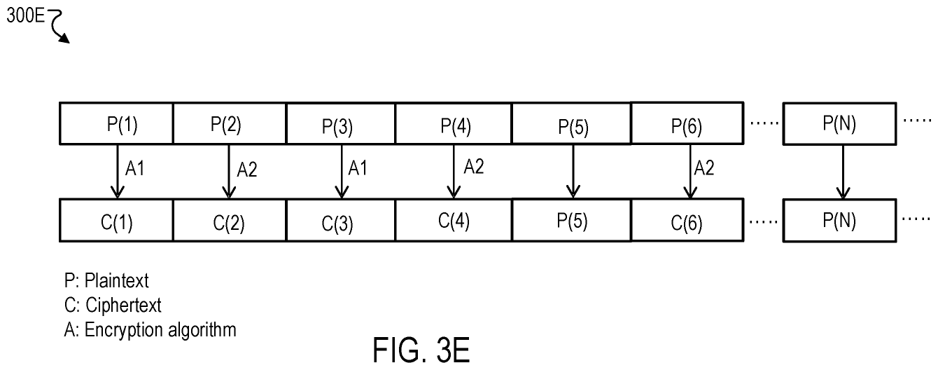

FIGS. 3A-3E illustrate examples of encryption mechanisms 300A-300E, for secure content transfer for a read operation. In some implementations, the encryption mechanisms 300A-300E are used by the memory device 110 and the host device 120, as described above. FIG. 3A shows encryption mechanism 300A, in which the content blocks are divided into a plurality of sections, such as sections 312 and 314, among others. A subset of the plaintext content blocks in each section is encrypted using an encryption algorithm, while remaining plaintext content blocks are unencrypted. For example, in section 312, plaintext content block P(1) is encrypted to generate ciphertext content block C(1), while plaintext content blocks P(2) and P(N) are sent unencrypted. In the section 314, plaintext content blocks P(N+1) and P(N+2) are encrypted to generate ciphertext content blocks C(N+1) and C(N+2) respectively, while plaintext content block P(2N) is sent unencrypted.

In addition to encrypting a subset of plaintext content blocks in each section, the encryption mechanism 300A enhances security by varying the number of content blocks per section that are encrypted. For example, as shown, only one plaintext content block, e.g., content block P(1), is encrypted in section 312, but two plaintext content blocks, e.g., content blocks P(N+1) and P(N+2), are encrypted in section 314.

In some implementations, the relative order of encrypted and unencrypted content blocks within a section can be different from other sections. As an example, in some implementations in section 312, the first plaintext content block P(1) is encrypted but the second plaintext content block P(2) is unencrypted, as shown, while a third plaintext content block P(3) that follows P(2) is also encrypted. In contrast, in section 314, the first and second plaintext content blocks P(N+1) and P(N+2) are encrypted, while a third plaintext content block P(N+3) is unencrypted. In such implementations, in addition to the encryption/decryption algorithms, additional parameters, e.g., the relative order of encryption in each section, are shared between the host device 120 and the memory controller 112.

FIG. 3B shows encryption mechanism 300B, in which the content blocks are divided into a plurality of sections, such as sections 322 and 324, among others, and a nonce is added to each section for enhanced security. As in the mechanism 300A, a subset of the plaintext content blocks in each section is encrypted in mechanism 300B using an encryption algorithm, while remaining plaintext content blocks are unencrypted. For example, in section 322, plaintext content block P(1) is encrypted to generate ciphertext content block C(1), while plaintext content blocks P(2) and P(N) are sent unencrypted; and in section 314, plaintext content block P(N+1) is encrypted to generate ciphertext content block C(N+1), while plaintext content blocks P (N+2) and P(2N) are sent unencrypted.

However, before encrypting the content blocks in a section, a nonce if added to the plaintext content in each block in mechanism 300B, and the <nonce +plaintext>content is then encrypted. Addition of the nonce, which is changed at certain time intervals, ensures that replay attacks are prevented. For example, in response to a read command at a first time, the memory device 110 adds a first nonce to the plaintext content blocks before encryption, generating ciphertext content blocks that include the first nonce. However, in response to a read command at a second time, the memory device 110 adds a different second nonce to the same plaintext content blocks before encryption, generating ciphertext content blocks that include the second nonce. Since the ciphertext content blocks at the first time and those at the second time are generated using different nonce values, the ciphertext content blocks are different at the first and second times. Accordingly, an eavesdropper who obtains some ciphertext content blocks at the first time, e.g., by probing the I/O pins of the memory device 110, will not be able to use these ciphertext blocks at the second time, since the ciphertext content blocks at the second time will be different. In this manner, replay attacks are prevented.

As described previously, in some implementations, the nonce is a random number that is changed at certain time intervals. To ensure that the memory device 110 and the host device 120 perform consistent encryption and decryption operations, the nonce is synchronized between the two devices whenever the nonce is changed. For example, the memory device 110 can generate a new nonce and then send an update to the host device 120. Alternatively, the host device 120 can generate a new nonce and then send an update to the memory device 110. In some implementations, the frequency at which the nonce is changed is configured by a user. Higher the frequency of nonce change, lower is the system performance due to the additional overhead of synchronizing the nonce between the host device and the memory device.

In some implementations, the encryption mechanisms 300A and 300B are combined. In such implementations, the number of plaintext content blocks in each section that are encrypted are varied from one section to another, as in mechanism 300A. Additionally, a nonce is added to the plaintext content blocks before encryption, as in mechanism 300B.

In some implementations, the same encryption algorithm is used, in the encryption mechanism 300A or 300B, or both, to encrypt the content blocks in the different sections, e.g., one of DES, AES, Blowfish, RC5, ECC or XOR, among others. However, in other implementations, different encryption algorithms are used in different sections in the encryption mechanism 300A or 300B, or both. For example, AES can be used in section 312 or 322, while RC5 can be used in section 314 or 324.

FIG. 3C shows encryption mechanism 300C, in which the content blocks are divided into a plurality of sections, such as sections 332 and 334, among others. In the mechanism 300C, all the plaintext content blocks in each section are encrypted, but different encryption mechanisms are used for subsets of content blocks in a section. For example, in section 332, plaintext content block P(1) is encrypted using encryption algorithm A1 to generate ciphertext content block C(1), while plaintext content blocks P(2) and P(N) are encrypted using a different encryption algorithm A2 to generate ciphertext content blocks C(2) and C(N) respectively. Similarly, in section 334, plaintext content block P(N+1) is encrypted using encryption algorithm A1 to generate ciphertext content block C(N+1), while plaintext content blocks P(N+2) and P(2N) are encrypted using encryption algorithm A2 to generate ciphertext content blocks C(N+2) and C(2N), respectively.

FIG. 3D shows encryption mechanism 300D, in which the content blocks are divided into a plurality of sections, such as sections 342 and 344, among others, with different subsets of plaintext content blocks in each section encrypted using different encryption mechanisms, while remaining plaintext content blocks in the section are unencrypted. For example, in section 342, plaintext content block P(1) is encrypted using encryption algorithm A1 to generate ciphertext content block C(1), plaintext content block P(2) is encrypted using encryption algorithm A2 to generate ciphertext content block C(2), while plaintext content block P(N) is unencrypted. Similarly, in section 344, plaintext content block P(N+1) is encrypted using encryption algorithm A1 to generate ciphertext content block C(N+1), plaintext content block P(N+2) is encrypted using encryption algorithm A2 to generate ciphertext content block C(N+2), while plaintext content block P(2N) is unencrypted.

In some implementations, in encryption mechanism 300C or 300D, or both, the encryption algorithm A1 is a standard encryption algorithm, e.g., one of DES, AES, Blowfish, ECC or RC5, while encryption algorithm A2 is a simplified encryption algorithm, e.g., one of XOR or FPE with prefix method. In some other implementations, in encryption mechanism 300C or 300D, or both, the encryption algorithm A1 is a simplified encryption algorithm, e.g., one of XOR or FPE with prefix method, while encryption algorithm A2 is a standard encryption algorithm, e.g., one of DES, AES, Blowfish, ECC or RC5. In this context, a simplified encryption algorithm has a lower computational overhead, e.g., lower processing cycles, lower processing times, or lower energy expenditure, compared to a standard encryption algorithm. Accordingly, when standard encryption is used, the memory device or the host device, or both, takes more time to encrypt or decrypt the content blocks or spends more energy for these cryptographic operations, or both, compared to cases where simplified encryption is used. In this manner, using a mix of standard and simplified encryption algorithms, strong security can be obtained, while reducing the computational overhead, e.g., compared to conventional cases where only a standard encryption algorithm is used.

In some implementations, the computational overhead is also reduced by encrypting a greater number of plaintext content blocks in each section with a simplified encryption algorithm, compared to the number of plaintext content blocks in a section encrypted with a standard encryption algorithm. For example, as shown, in section 332, a subset of one plaintext content block, P(1), is encrypted using standard encryption algorithm A1, but a larger subset of multiple plaintext content blocks, P(2), . . . , P(N), are encrypted using the simplified encryption algorithm A2. Similarly, in section 334, a subset of one plaintext content block, P(N+1), is encrypted using standard encryption algorithm A1, but a larger subset of multiple plaintext content blocks, P(N+2), . . . , P(2N), are encrypted using the simplified encryption algorithm A2. Further, the computational overhead of mechanism 300D is less compared to the computational overhead of mechanism 300C, since a lesser number of plaintext content blocks are encrypted in the mechanism 300D (e.g., some plaintext content blocks are unencrypted in each section) compared to the mechanism 300C (e.g., all plaintext content blocks are encrypted in each section).

In some implementations, more than one standard encryption algorithm, or more than one simplified encryption algorithm, or both, are used in each section in the encryption mechanism 300C, or 300D, or both. For example, in such cases, a first plaintext content block in a section is encrypted using standard encryption algorithm A1, a second plaintext content block in the section is encrypted using simplified encryption algorithm A2, and a third plaintext content block in the section is encrypted using a different simplified encryption algorithm A3. Alternatively, a first plaintext content block in a section is encrypted using standard encryption algorithm A1, a second plaintext content block in the section is encrypted using a different standard encryption algorithm A1′, while a third plaintext content block in the section is encrypted using simplified encryption algorithm A2. Different permutations of encryption algorithms can be used, e.g., two or three standard encryption algorithms and two or three simplified encryption algorithms in each section.

In some implementations, similar sets of encryption algorithms are used in the encryption mechanism 300C or 300D, or both, to encrypt the content blocks in the different sections. For example, the same standard encryption algorithm A1 and same simplified encryption algorithm A2 are used in all sections, as shown. However, in other implementations, different sets of encryption algorithms are used in different sections in the encryption mechanism 300C or 300D, or both. For example, the standard encryption algorithm and/or the simplified encryption algorithm used in section 332 can be different from the standard encryption algorithm and/or the simplified encryption algorithm, respectively, used in section 334. In some implementations, in addition to using multiple encryption algorithms in each section, a nonce is also used, e.g., in a manner similar to that in mechanism 300B.

In some implementations, the memory device and the host device use preselected values to determine the number of plaintext content blocks in a section that will be encrypted using standard or simplified encryption algorithms, or both, and the number of plaintext content blocks that will be transmitted unencrypted. For example, considering an implementation in which the encryption mechanism 300D is used, a first numerical value, SEC_CNT, indicates a total number of plaintext content blocks in a section, which is same across the different sections. A second numerical value, STD_CNT, indicates the number of plaintext content blocks in a section to be encrypted using the standard encryption algorithm, and a third numerical value, SMP_CNT, indicates the number of plaintext content blocks in the section to be encrypted using the simplified encryption algorithm. Accordingly, the number of content blocks that will remain unencrypted is given by subtracting (STD_CNT+SMP_CNT) from SEC_CNT, since:

STD_CNT+SMP_CNT+(number of plaintext content blocks)=SEC_CNT

To illustrate, consider an example in which the content sections, e.g., sections 342 and 344, have five content blocks each (e.g., SEC_CNT=5), with STD_CNT=1 and SMP_CNT=2. In this case, in each section, one plaintext content block, e.g., P(1) or P(N+1), is encrypted using standard encryption algorithm, since STD_CNT=1. Additionally, in each section, two plaintext content blocks are encrypted using simplified encryption algorithm, e.g., P(2) and P3 (not shown) or P(N+2) and P(N+3) (not shown), since SMP_CNT=2. The remaining two plaintext content blocks in each section are sent unencrypted, since SEC_CNT−(STD_CNT+SMP_CNT)=5−(1+2)=2.

In some implementations, when the memory device 110 prepares secured content for sending to the host device 120, the memory device uses a counter to track, e.g., count, a number of content blocks in a section that are encrypted using standard encryption algorithm (e.g., equal to STD_CNT), a number of content blocks in a section that are encrypted using a simplified encryption algorithm (e.g., equal to SMP_CNT), and a number of content blocks in a section that are sent unencrypted (e.g., difference of SEC_CNT and (STD_CNT+SMP_CNT)). Additionally or alternatively, in some implementations, when the host device 120 processes secured content received from the memory device 110 in response to a read request, the host device 120 uses a counter to track, e.g., count, a number of content blocks in a section that the host device decrypts using standard encryption algorithm (e.g., equal to STD_CNT), a number of content blocks in a section that the host device decrypts using a simplified encryption algorithm (e.g., equal to SMP_CNT), and the remaining number of content blocks in a section that the host device received unencrypted (e.g., SEC_CNT−(STD_CNT+SMP_CNT)). The use of the preselected values is described in detail with respect to processes 600 and 700 below.

In some implementations, the numerical values SEC_CNT, STD_CNT and SMP_CNT are stored in the memory device 110, e.g., in the registers 114. In other implementations, the numerical values SEC_CNT, STD_CNT and SMP_CNT are stored in memory locations in the storage memory 116, e.g., processor on-chip memory. In some implementations, the numerical values SEC_CNT, STD_CNT and SMP_CNT are configurable, e.g., set by a user. In some implementations, a user sets the values of SEC_CNT, STD_CNT and SMP_CNT through a user interface coupled to the host device 120, and the values are subsequently stored in the memory device 110.

In some implementations, the number of content blocks that are encrypted, the relative arrangement of encrypted content blocks, the encryption algorithms that are used, or any suitable combination of these, vary from one read operation to another read operation. FIG. 3E shows encryption mechanism 300E, in which one or more groups of dispersed plaintext content blocks are encrypted, while remaining plaintext content blocks are unencrypted. For example, as shown, in some implementations, plaintext content blocks P(1), P(2), P(3), P(4) and P(6) are encrypted to generate respective ciphertext content blocks C(1), C(2), C(3), C(4) and C(6), while remaining plaintext content blocks, e.g., P(5) and P(N), are unencrypted. Different encryption mechanisms can be used to encrypt the content blocks. For example, plaintext content blocks P(1) and P(3) are encrypted using encryption algorithm A1 to generate ciphertext content blocks C(1) and C(3) respectively, while plaintext content blocks P(2), P(4) and P(6) are encrypted using encryption algorithm A2 to generate ciphertext content blocks C(2), C(4) and C(6). In some implementations, A1 is a standard encryption algorithm and A2 is a simplified encryption algorithm. In some other implementations, A1 is a simplified encryption algorithm and A2 is a standard encryption algorithm.

As shown, in some implementations, the content blocks that are encrypted using one encryption algorithm, e.g., plaintext content blocks P(1) and P(3), can be intermingled with the content blocks that are encrypted using a different encryption algorithm, e.g., plaintext content blocks P(2) and P(4). Also, in some implementations, the encrypted content blocks, e.g., ciphertext content blocks C(4) and C(6), can be intermingled with unencrypted content blocks, e.g., unencrypted plaintext content block P(5). In some other implementations, content blocks that are encrypted using any particular specific encryption algorithm, encryption algorithm A1 or A2, are contiguous. Additionally or alternatively, in some implementations, encrypted content blocks are contiguous and unencrypted content blocks are also contiguous.

In some implementations, the numbers of content blocks that are encrypted using encryption algorithm A1 or encryption algorithm A2, or both, vary from one read operation to another read operation. In some implementations, the relative arrangement of content blocks that are encrypted using encryption algorithm A1 or encryption algorithm A2, or both, and the number of encrypted content blocks, vary from one read operation to another read operation. In some implementations, the order in which the encryption algorithms A1 or A2 are applied vary from one read operation to another read operation.

Accordingly, in implementations that use the encryption mechanism 300E, the numbers of encrypted and unencrypted content blocks, the relative arrangement of encrypted and unencrypted content blocks, the encryption algorithms that are used, or the order of applying one or more encryption algorithms, or any suitable combination of these, differ from one read operation to another read operation. In such implementations, the relevant parameters for the encryption and decryption operations, e.g., number of encrypted and unencrypted content blocks, numbers of content blocks encrypted using first or second encryption algorithms, the algorithms used, the order of applying the algorithms, or the relative arrangement of the encrypted and unencrypted content blocks, among other parameters, are exchanged between the host device 120 and the memory controller 112 for successful read operations. In such implementations, the parameters specify the locations of the encrypted and unencrypted content blocks, instead of counter values, which are not used.

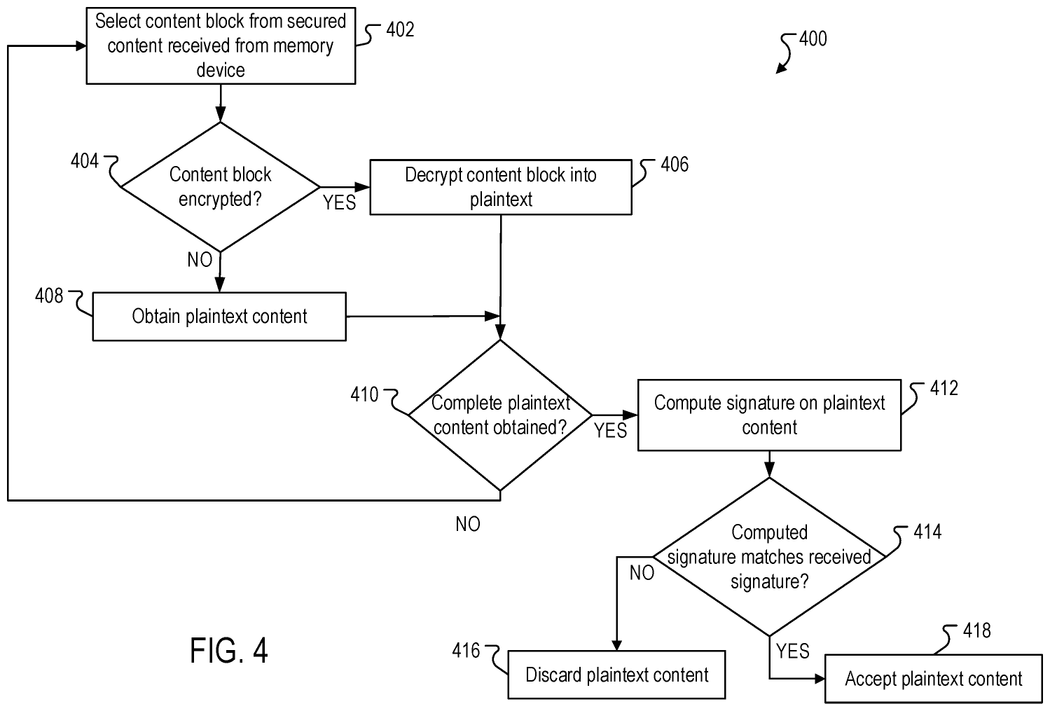

FIG. 4 illustrates an example of a process 400 to read secured content received from a memory device. In some implementations, the process 400 is performed by the host device 120, e.g., using the processor 122, upon receiving secured content from the memory device 110 in response to a read command. Accordingly, the following sections describe the process 400 with respect to the host device 120. However, the process 400 also may be performed by other devices.

The process 400 starts when the host device selects a content block from the secured content received from the memory. For example, the host device 120 sends a read command to the memory device 110. In response, the memory device 110 sends back the requested content in a secured version, where the secured content includes a plurality of sections with each section having one or more content blocks. For example, the memory device 110 sends back a mixture of encrypted ciphertext content blocks and unencrypted plaintext content blocks, along with a signature block, such as C(1), P(2), . . . , P(N), C(N+1), P(N+2), . . . , P(2N), and CRC 202, described with respect to FIG. 2. A subset of the content blocks in each section is encrypted in ciphertext form (e.g., using one of the encryption algorithms described previously, such as AES, DES, RC5, ECC, XOR or FPE), while the remaining content blocks in each section are unencrypted plaintext form. For example, C(1) and C(N+1) are encrypted ciphertext content blocks, while P(2), . . . , P(N), P(N+2), . . . , P(2N) are unencrypted plaintext content blocks. Upon receiving the secured content, the host device 120 processes each section of content. While processing a section, the host device selects a content block in the section.

The host device determines whether the content block is encrypted (404). For example, for the selected content block, the host device checks whether the content block is encrypted ciphertext or unencrypted plaintext. In some implementations, specified content blocks within a section are encrypted, with the configuration of encrypted and unencrypted content blocks within a section known to both the memory device and the host device, e.g., through an earlier “handshake” message exchange. For example, in some implementations, the encryption mechanism 300B is used, in which the first content block in each section is encrypted while remaining content blocks in the section are unencrypted. Accordingly, by agreeing upon the particular encryption mechanism in an earlier handshake mechanism with the memory device 110, the host device 120 will know, when processing a section, which content blocks within the section are encrypted. As another example, in some implementations, the encryption mechanism 300E is used, in which, for each read operation, different number of content blocks are encrypted, the relative arrangement of encrypted and unencrypted content blocks vary, the one or more encryption algorithms used differ, or the arrangement of content blocks encrypted using different encryption algorithms are different, or any suitable combination of these parameters. Accordingly, by exchanging these particular parameters through a handshake mechanism with the memory device 110, the host device 120 will know, when processing content blocks for a read operation, which content blocks are encrypted or the encryption algorithm used, or both.

If the host device determines that the content block is encrypted, then the host device decrypts the content block into plaintext (406). For example, the host device 120 determines that the selected content block is the first content block of the present section, which is encrypted (e.g., using encryption mechanism 300B). Upon this determination, the host device 120 decrypts the content block to obtain the corresponding plaintext. As described previously, the host device 120 uses a complementary cryptographic mechanism to that used by the memory device 110 for encryption. For example, the host device 120 decrypts ciphertext content blocks C(1) and C(N+1) to obtain the corresponding plaintext content blocks P(1) and P(N+1), respectively.

In some implementations, upon decrypting the content block, the result is a combination of a nonce and the plaintext content, e.g., when encryption mechanism 300B is used. In such cases, after decrypting the content block, the host device 120 removes the nonce from the result to obtain the plaintext content.

On the other hand, if the host device determines that the content block is not encrypted, then the host device directly obtains the plaintext content from the content block (408). For example, the host device 120 determines that the selected content block is the second or subsequent content block of the present section, which is unencrypted (e.g., using encryption mechanism 300B). Upon this determination, the host device 120 extracts the plaintext content of the content block. For example, the host device 120 determines that the content block is one of P(2), P(N), P(N+2), or P(2N), from which the host device obtains the plaintext directly without decryption.

The host device determines whether complete plaintext content has been obtained (410). For example, the host device 120 checks whether it has completed processing of all the content blocks in all the sections of the secured content received from the memory device 110.

If the host device determines that complete plaintext content has not been obtained, then the host device continues processing the remaining sections of the secured content received from the memory device, selecting and processing content blocks for the remaining sections (402)-(408). On the other hand, if the host device determines that the complete plaintext content has been obtained, then the host device computes a signature on the plaintext content (412). For example, the host device 120 computes a digital signature, such as CRC 204, on the plaintext content blocks across all the sections that it has processed, such as P(1), P(2), . . . , P(N), P(N+1), P(N+2), . . . , P(2N). As described previously, the host device 120 uses a suitable cryptographic algorithm for computing the signature, e.g., CRC, MD5 or SHA. The cryptographic algorithm used by the host device matches the algorithm that the memory device 110 used to generate the digital signature on the requested content before sending to the host device.

The host device checks whether the computed signature matches the received signature (414). For example, the host device 120 compares the digital signature it computed at (412), e.g., CRC 204, with the digital signature that it received as part of the secured content from the memory device 110, e.g., CRC 202.

If the computed signature does not match the received signature, then the host device discards the plaintext content (416). For example, if the host device 120 determines that the signature it computed at (412), e.g., signature CRC 204, does not match the signature it received from the memory device 110 as part of the secured content, e.g., signature CRC 202, then the host device determines the secured content received from the memory device as having been forged or falsified, and accordingly discards the plaintext content, e.g., content blocks P(1), P(2), . . . , P(N), P(N+1), P(N+2), . . . , P(2N), that it obtained from the secured content.

On the other hand, if the computed signature matches the received signature, then the host device accepts the plaintext content (418). For example, if the host device 120 determines that the signature computed at (412), e.g., signature CRC 204, matches the signature received from the memory device 110 as part of the secured content, e.g., signature CRC 202, then the host device determines the secured content received from the memory device as being legitimate, and accordingly accepts the plaintext content, e.g., content blocks P(1), P(2), . . . , P(N), P(N+1), P(N+2), . . . , P(2N), that are obtained from the secured content. The host device 120 subsequently performs further processing on the secured content. For example, if the requested content is boot code, then the host device executes the boot code.

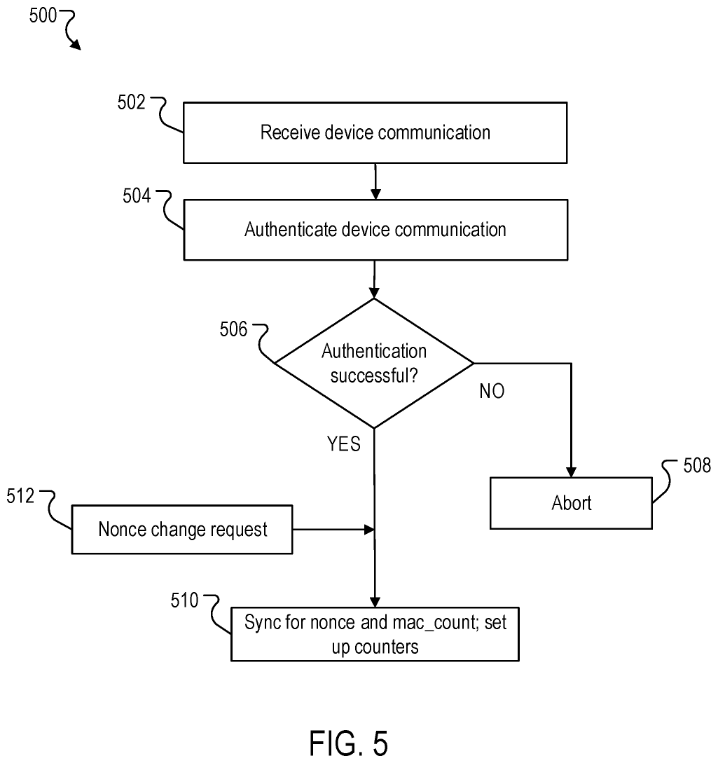

FIG. 5 illustrates an example of a process 500 to synchronize security mechanisms between a host device and a memory device. In some implementations, the process 500 is performed by the memory device 110 (e.g., by the memory controller 112), or the host device 120 (e.g., by the processor 122), or both, to determine one of more of cryptographic encryption/decryption, signature generation/verification, or nonce updates that would be used by the memory device 110 and the host device 120. Accordingly, the following sections describe the process 500 with respect to the memory device 110 and the host device 120. However, the process 500 also may be performed by other devices.

In some implementations, the process 500 is performed during initialization of secure memory read operations, e.g., when the host device 120, or the memory device 110, or both are powered on. In some implementations, the process 500 is performed in conjunction with, and before, the process 400 described above, or the processes 600 or 700 described below.

The process 500 starts when a device communication is received (502). For example, the host device 120 can receive a handshake message from the memory device 110 to agree upon the cryptographic encryption/decryption, signature generation/verification, or nonce initialization such that secure content can be successfully exchanged between the two devices. Alternatively, the memory device 110 can receive a handshake message from the host device 120 to agree upon the cryptographic encryption/decryption, signature generation/verification, or nonce initialization such that secure content can be successfully exchanged between the two devices.

The device communication is authenticated (504). For example, in some implementations, upon receiving a handshake message from the memory device 110, the host device 120 checks a digital signature sent with the message to determine whether the message was indeed sent by the memory device 110, and to confirm that the message was not forged or falsified. Alternatively, in some implementations, upon receiving a handshake message from the host device 120, the memory device 110 checks a digital signature sent with the message to determine whether the message was sent by the host device 120, and to confirm that the message was not forged or falsified.

It is determined whether authentication is successful (506). For example, in some implementations, the host device 120, upon authenticating the handshake message received from the memory device 110, determines whether the digital signature sent with the message is successfully verified. Alternatively, in some implementations, the memory device 110, upon authenticating the handshake message received from the host device 120, determines whether the digital signature sent with the message is successfully verified.

If the authentication is not successful, then the process is aborted (508). For example, if the host device 120 cannot successfully verify the digital signature sent with the handshake message from the memory device 110, then the host device 120 rejects the handshake request from the memory device 110. Alternatively, if the memory device 110 cannot successfully verify the digital signature sent with the handshake message from the host device 120, then the memory device 110 rejects the handshake request from the host device 120.

On the other hand, if the authentication is successful, then synchronization is done for nonce and mac_count, and counters are set up (510). For example, if the host device 120 successfully verifies the digital signature sent with the handshake message from the memory device 110, then the host device 120 accepts the handshake request from the memory device 110 and proceeds to synchronize the parameters used for receiving secured content from the memory device 110. Alternatively, if the memory device 110 successfully verifies the digital signature sent with the handshake message from the host device 120, then the memory device 110 accepts the handshake request from the host device 120 and proceeds to synchronize the parameters used for sending secured content to the host device 120.

The parameters include an initial value for the nonce and the mac_count. In this context, mac_count is a bit counter, e.g., an 8-bit or a 16-bit counter, that is used to determine a number of times a nonce value is reused. For example, for an 8-bit mac_count, a nonce value can be reused 256 times (for mac_count value ranging from 0 to 255). Every time a nonce value is used, the mac_count counter is incremented. When the counter value reaches 255, the nonce is renewed, e.g., a new nonce value is generated, and the mac_count value is reset to 0. In this manner, the mac_count parameter is used to reduce the overhead associated with frequently changing the nonce to prevent replay attacks.

The parameters also include a selection of the encryption/decryption algorithm(s), signature algorithm, key seed, and values for STD_CNT (e.g., how many plaintext content blocks per section will be encrypted using the selected standard encryption algorithm), SMP_CNT (e.g., how many plaintext content blocks per section will be encrypted using the selected simplified encryption algorithm) and SEC_CNT (e.g., how many content blocks per section will be included in each section).

In some implementations, values for the parameters are included in the handshake message itself. In such cases, the host device 120 accepts the values sent with the handshake message from the memory device 110. Alternatively, the memory device 110 accepts the values sent with the handshake message from the host device 120. In other implementations, after accepting the handshake message, the host device 120, or the memory device 110, as the case may be, has further message exchanges with the other device to agree upon values of the parameters noted above.

Once the parameter values are agreed upon, the memory device 110 sends secured content to the host device 120 in response to read commands, securing the content using the agreed-upon values of the parameters and the host device processes the secured content by relying on the agreed-upon values of the parameters.

Additionally, in some implementations, a nonce change request is received and processed (512). For example, after an initial successful handshake message exchange as described with respect to (502)-(510), the memory device 110 or the host device 120 can update the nonce value from time to time. To perform the update, a nonce change request is sent to the other device, e.g., with a new value for the nonce, and the receiving device processes the nonce change request to synchronize the new value of the nonce with its locally stored value.

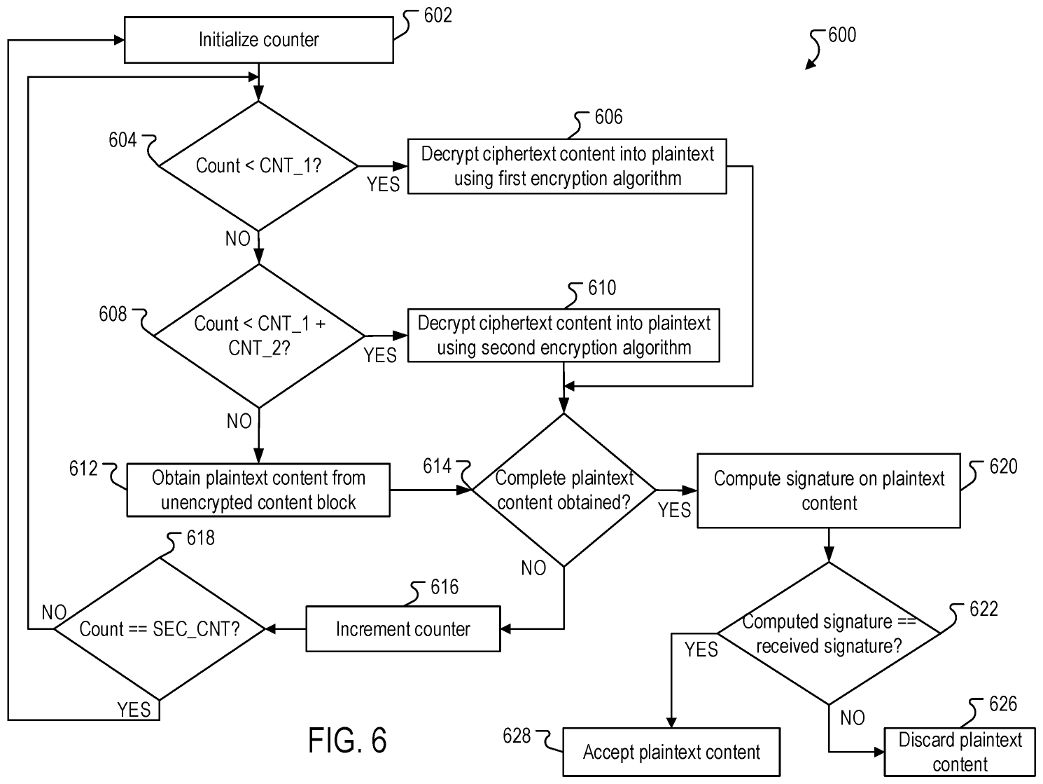

FIG. 6 illustrates an example of a process 600 to read secured content received from a memory device. In some implementations, the process 600 is performed by the host device 120 to read secured content received from the memory device 110 in response to a read command, where the content is secured using encryption mechanism 300D. Accordingly, the following sections describe the process 600 with respect to the host device 120. However, the process 600 also may be performed by other devices.

The process 600 starts when the host device initializes a counter (602). For example, as described previously, in some implementations, the host device 120 uses a counter to determine, in each section of the secured content that the host device receives from the memory device 110, a number of content blocks in the section that the host device decrypts using standard encryption algorithm (e.g., equal to STD_CNT), a number of content blocks in the section that the host device decrypts using a simplified encryption algorithm (e.g., equal to SMP_CNT), and the remaining number of content blocks in the section that the host device receives as unencrypted plaintext (e.g., SEC_CNT−(STD_CNT+SMP_CNT)). As described previously, the values of SEC_CNT, STD_CNT and SMP_CNT are preselected and agreed upon by the host device 120 and the memory device 110.

In such implementations, at the beginning of processing each selected section of the secured content, the host device selects a content block corresponding to the section and initializes its counter, e.g., by setting the counter value to zero. For example, the host device 120 sends a read command to the memory device 110 and in response, the memory device 110 sends back the requested content in a secured version, which includes a mixture of encrypted ciphertext content blocks and unencrypted plaintext content blocks, along with a signature block, such as C(1), C(2), . . . , P(N), C(N+1), C(N+2), . . . , P(2N), and CRC 202. A subset of the content blocks in each section is encrypted in ciphertext form, while the remaining content blocks in each section are unencrypted plaintext form. For example, as shown in FIG. 3D, in section 342, C(1) and C(2) are encrypted ciphertext content blocks while P(N) is unencrypted plaintext content block; and in section 344, C(N+1) and C(N+2) are encrypted ciphertext content blocks while P(2N) is unencrypted plaintext content block. Upon receiving the secured content, the host device 120 processes each section of content. While selecting a section for processing by selecting the first content block in a section, e.g., C(1) or C(N+1), the host device initializes the counter value.

The host device determines whether value of the counter is less than CNT_1 (604). For example, using the encryption mechanism 300D, in some implementations, the host device processes the content blocks in a selected section in the following sequence, incrementing the counter value by one after each content block is processed: a first subset of the content blocks (e.g., equal to the value of STD_CNT) is decrypted using a standard encryption algorithm, a second subset of the content blocks (e.g., equal to the value of SMP_CNT) is decrypted using a simplified encryption algorithm, while the remaining content blocks in the section are unencrypted (e.g., equal to SEC_CNT−(STD_CNT+SMP_CNT)). To illustrate, as an example, in some implementations of the mechanism 300D in FIG. 3D, STD_CNT=1 and SMP_CNT=1, which indicates that, in section 342, ciphertext content block C(1) is encrypted using standard encryption algorithm (e.g., STD_CNT=1) and ciphertext content block C(2) is encrypted using a simplified encryption algorithm (e.g., SMP_CNT=1), while remaining content blocks, such as P(N), are unencrypted plaintext content blocks. Similarly, in section 344, C(N+1) and C(N+2) are ciphertext content blocks encrypted using the standard and the simplified encryption algorithms, respectively, while P(2N) is unencrypted plaintext content block. In such implementations, CNT_1==STD_CNT. Accordingly, in such implementations, when reading a selected content block in a selected section of the received secured content, following the above sequence, the host device 120 first checks whether all ciphertext content blocks using standard encryption in the presently selected section have been processed, by comparing its counter value to STD_CNT.

In some implementations, the order in which standard and simplified encryption algorithms are used is reversed. In such implementations, content blocks in each section are processed in the following sequence: a first subset of the content blocks (e.g., equal to the value of SMP_CNT) is encrypted or decrypted using a simplified encryption algorithm, a second subset of the content blocks (e.g., equal to the value of STD_CNT) is encrypted or decrypted using a standard encryption algorithm, while the remaining content blocks in the section are unencrypted. As an illustrative example, in some implementations of the mechanism 300D in FIG. 3D, SMP_CNT=1 and STD_CNT=1. In such implementations, in section 342, ciphertext content block C(1) is encrypted using simplified encryption algorithm (e.g., SMP_CNT=1) and ciphertext content block C(2) is encrypted using a standard encryption algorithm (e.g., STD_CNT=1), while remaining content blocks, such as P(N), are unencrypted plaintext content blocks. Similarly, in section 344, C(N+1) and C(N+2) are ciphertext content blocks encrypted using the simplified and the standard encryption algorithms, respectively, while P(2N) is unencrypted plaintext content block. In such implementations, CNT_1==SMP_CNT. Accordingly, in such implementations, when reading a selected content block in a selected section of the received secured content, following the above sequence, the host device 120 first checks whether all ciphertext content blocks using standard encryption in the presently selected section have been processed, by comparing its counter value to SMP_CNT.

If the host device determines that the value of the counter is less than CNT_1, then the host device decrypts the presently selected ciphertext content block in the presently selected section into plaintext using a first encryption algorithm (606). For example, in implementations where CNT_1==STD_CNT, the first encryption algorithm is a standard encryption algorithm. In such implementations, when the counter value is less than STD_CNT, then the host device 120 determines that not all ciphertext content blocks encrypted using the standard encryption algorithm, e.g., in the first subset of content blocks in the section, have been processed. Accordingly, for the presently selected ciphertext content block of the section, the host device 120 decrypts the ciphertext using the standard encryption algorithm. For example, in such implementations, the host device 120 decrypts ciphertext content block C(1) in section 342 using the standard encryption algorithm to obtain the corresponding plaintext content block P(1). Similarly, when processing section 344, the host device 120 decrypts the ciphertext content block C(N+1) using the standard encryption algorithm to obtain the corresponding plaintext content block P(N+1).

As another example, in implementations where CNT_1==SMP_CNT, the first encryption algorithm is a simplified encryption algorithm. In such implementations, when the counter value is less than SMP_CNT, then the host device 120 determines that not all ciphertext content blocks encrypted using the simplified encryption algorithm, e.g., in the first subset of content blocks in the section, have been processed. Accordingly, for the presently selected ciphertext content block of the section, the host device 120 decrypts the ciphertext using the simplified encryption algorithm. For example, in such implementations, the host device 120 decrypts ciphertext content block C(1) in section 342 using the simplified encryption algorithm to obtain the corresponding plaintext content block P(1). Similarly, when processing section 344, the host device 120 decrypts the ciphertext content block C(N+1) using the simplified encryption algorithm to obtain the corresponding plaintext content block P(N+1).

On the other hand, if the host device determines that the value of the counter is equal to or greater than CNT_1, then the host device further checks whether value of the counter is less than CNT_1+CNT_2 (608). For example, in implementations where CNT_1==STD_CNT, CNT_2==SMP_CNT. In such implementations, when the first subset of content blocks in the section have been processed, such that the value of the counter is at least equal to STD_CNT, the host device 120 then checks whether any content block in the second subset of content blocks in the section, e.g. using the simplified encryption algorithm, are remaining to be processed, by comparing the total number of content blocks processed to STD_CNT+SMP_CNT. In implementations where CN_1==SMP_CNT, CNT_2==STD_CNT. In such implementations, when the first subset of content blocks in the section have been processed using the simplified encryption algorithm, such that the value of the counter is at least equal to SMP_CNT, the host device 120 then checks whether any content block in the second subset of content blocks in the section, e.g. using the standard encryption algorithm, are remaining to be processed, by comparing the total number of content blocks processed to SMP_CNT+STD_CNT.

If the host device determines that the value of the counter is less than CNT_1+CNT_2, then the host device decrypts ciphertext content into plaintext using a second encryption algorithm (610). For example, in implementations where CNT_1==STD_CNT and CNT_2==SMP_CNT, the second encryption algorithm is a simplified encryption algorithm (while the first encryption algorithm is a standard encryption algorithm, as noted above). In such implementations, when the counter value is greater than STD_CNT but less than STD_CNT+SMP_CNT, then the host device 120 determines that not all ciphertext content blocks encrypted using the simplified encryption algorithm, e.g., in the second subset of content blocks in the section, have been processed. Accordingly, for the presently selected ciphertext content block of the section, the host device 120 decrypts the ciphertext using the simplified encryption algorithm. For example, the host device 120 decrypts ciphertext content block C(2) in section 342 using the simplified encryption algorithm to obtain the corresponding plaintext content block P(2). Similarly, when processing section 344, the host device 120 decrypts the ciphertext content block C(N+2) using the simplified encryption algorithm to obtain the corresponding plaintext content block P(N+2). As another example, in implementations where CNT_1==SMP_CNT and CNT_2==STD_CNT, the second encryption algorithm is a standard encryption algorithm (while the first encryption algorithm is a simplified encryption algorithm, as noted above). In such implementations, when the counter value is greater than SMP_CNT but less than SMP_CNT+STD_CNT, then the host device 120 determines that not all ciphertext content blocks encrypted using the standard encryption algorithm, e.g., in the second subset of content blocks in the section, have been processed. Accordingly, for the presently selected ciphertext content block of the section, the host device 120 decrypts the ciphertext using the standard encryption algorithm. For example, the host device 120 decrypts ciphertext content block C(2) in section 342 using the standard encryption algorithm to obtain the corresponding plaintext content block P(2). Similarly, when processing section 344, the host device 120 decrypts the ciphertext content block C(N+2) using the standard encryption algorithm to obtain the corresponding plaintext content block P(N+2).

On the other hand, if the host device determines that the value of the counter is equal to or greater than CNT_1+CNT_2, then the host device obtains plaintext content from an unencrypted content block (612). For example, when the first and second subsets of content blocks in the section have been processed, such that the value of the counter is at least equal to CNT_1+CNT_2, then the remaining content blocks in the section are unencrypted content blocks. Accordingly, the host device 120 obtains the plaintext content from these unencrypted content blocks without any further cryptographic operations. For example, the host device 120 obtains the plaintext content from the unencrypted content block P(N) in section 342. Similarly, when processing section 344, the host device 120 obtains the plaintext content from the unencrypted content block P(2N).

After processing each content block, e.g., after decrypting the selected content block using the first encryption algorithm (606) or the second encryption algorithm (610), or after obtaining plaintext content from an unencrypted content block (612), the host device checks whether complete plaintext content has been obtained from the received secured content (614). If the host device determines that the complete plaintext content has not been obtained, e.g., not all sections, or all content blocks in a section, have been processed, then the host device increments the counter (616). For example, after processing each content block in a section, if the host device 120 determines that there are additional content blocks remaining to be processed, either in the present section or in a new section, then the host device increments its counter value and proceeds to select another content block in the present section, or a new section. For example, after processing content block C(1) in section 342, the host device 120 determines that there are additional content blocks to be processed in the section, such as content blocks C(2) and P(N). The host device then increments the counter and selects the next content block in the section, such as C(2).

The host device determines whether value of the counter is equal to SEC_CNT (618). For example, the host device 120 determines whether all the content blocks in the present section—the first and second subsets of ciphertext content blocks and the remaining plaintext content blocks—have been processed, which is indicated by the value of the host device counter being equal to SEC_CNT, e.g., the total number of content blocks in a section.

If the host device determines that the value of the counter is not equal to SEC_CNT (618), then the host device continues to process additional blocks in the presently selected section (604)-(616). For example, when not all content blocks in the presently selected section has been processed, either in the first subset of content blocks (604)-(606), or the second subset of content blocks (608)-(610), or the remaining plaintext content blocks (612), then the value of the host device counter is less than SEC_CNT. Accordingly, the host device 120 continues to process the remaining content blocks in the present section. For example, after processing content block C(2) in section 342, the host device 120 determines that not all content blocks in the section 342 have been processed, and the counter value is less than SEC_CNT. The host device 120 then selects the next content block in the section 342 for processing.

On the other hand, if the host device determines that the value of the counter is equal to SEC_CNT (618), then the host device selects a new section and initializes the counter value (602) to process the content blocks in the newly selected section, following the operations as described with respect to (604)-(616). For example, after processing content block P(N) in section 342, the host device 120 determines that all content blocks in the section 342 have been processed, and the counter value is equal to SEC_CNT. The host device 120 then resets its counter value to zero and processes the next section of secured content, e.g., section 344.

Reverting to (614), if the host device determines that the complete plaintext content has been obtained, e.g., all sections of the received secured content have been processed, then the host device computes a signature on the plaintext content (620). For example, after processing all the content blocks in all the sections of the received content as described above, the host device 120 computes a digital signature on the complete plaintext content that it has obtained. For example, the host device 120 computes a digital signature, such as CRC 204, on the plaintext content blocks across all the sections that it has processed, such as P(1), P(2), . . . , P(N), P(N+1), P(N+2), . . . , P(2N). As described previously, the host device 120 uses a suitable cryptographic algorithm for computing the signature, e.g., CRC, MD5 or SHA. The cryptographic algorithm used by the host device matches the algorithm that the memory device 110 used to generate the digital signature on the requested content before sending to the host device.

The host device checks whether the computed signature matches the received signature (622). For example, the host device 120 compares the digital signature it computed, e.g., CRC 204, with the digital signature that it received as part of the secured content from the memory device 110, e.g., CRC 202.

If the computed signature does not match the received signature, then the host device discards the plaintext content (626). For example, if the host device 120 determines that the signature it computed, e.g., signature CRC 204, does not match the signature it received from the memory device 110 as part of the secured content, e.g., signature CRC 202, then the host device determines the secured content received from the memory device as having been forged or falsified, and accordingly discards the plaintext content, e.g., content blocks P(1), P(2), . . . , P(N), P(N+1), P(N+2), . . . , P(2N), that it obtained from the secured content.

On the other hand, if the computed signature matches the received signature, then the host device accepts the plaintext content (628). For example, if the host device 120 determines that the signature it computed, e.g., signature CRC 204, matches the signature it received from the memory device 110 as part of the secured content, e.g., signature CRC 202, then the host device determines the secured content received from the memory device as being legitimate, and accordingly accepts the plaintext content, e.g., content blocks P(1), P(2), . . . , P(N), P(N+1), P(N+2), . . . , P(2N), that it obtained from the secured content. The host device 120 subsequently performs further processing on the secured content. For example, if the requested content is boot code, then the host device executes the boot code.

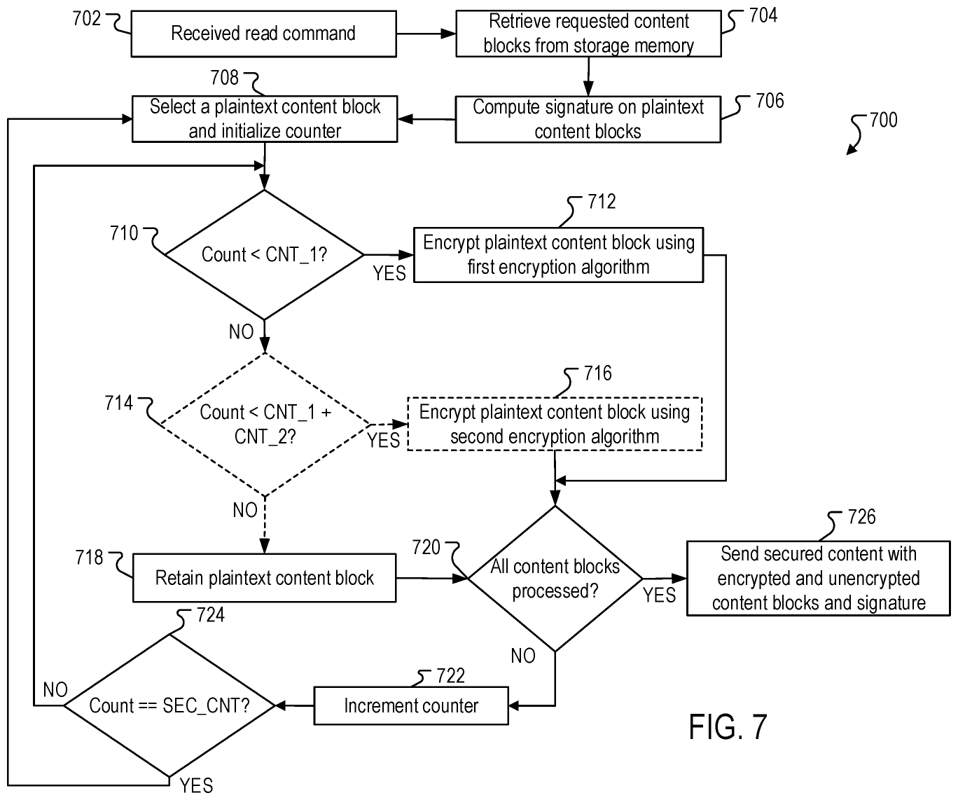

FIG. 7 illustrates an example of a process 700 to generate secured content for sending to a host device. In some implementations, the process 700 is performed by the memory device 110 to generate secured content in response to a read command from the host device 120, where the content is secured using encryption mechanism 300D. Accordingly, the following sections describe the process 700 with respect to the memory device 110. However, the process 700 also may be performed by other devices.

The process 700 starts when the memory device receives a read command (702). For example, the memory device 110 receives a read command from the host device 120, where the read command requests sending secured content to the host device, e.g., boot code, that is stored in the storage memory 116.

The memory device retrieves the requested content blocks from storage memory (704). For example, the memory device 110 (e.g., memory controller 112) accesses the storage memory 116 and the retrieves the requested content from the respective memory locations in the storage memory 116.

The memory device computes a signature on the plaintext content blocks (706). For example, the memory device 110 retrieves the requested content, which includes unencrypted plaintext content blocks P(1), P(2), . . . , P(N), P(N+1), P(N+2), . . . and P(2N). The memory device 110 computes a signature on these plaintext content blocks, such as CRC 202.

The memory device selects a plaintext content block and initializes the counter (708). For example, as described previously, in some implementations, the memory device 110 uses a counter to determine, in each section of the requested content, a number of content blocks in the section to encrypt using standard encryption algorithm (e.g., equal to STD_CNT), a number of content blocks in the section to encrypt using a simplified encryption algorithm (e.g., equal to SMP_CNT), and the remaining number of content blocks in the section to send as unencrypted plaintext (e.g., SEC_CNT−(STD_CNT+SMP_CNT)). As described previously, the values of SEC_CNT, STD_CNT and SMP_CNT are preselected and agreed upon by the host device 120 and the memory device 110.

In such implementations, at the beginning of processing each selected section of the requested content, the memory device selects a content block corresponding to the section and initializes its counter, e.g., by setting the counter value to zero. A subset of the content blocks in each section is encrypted in ciphertext form, while the remaining content blocks in each section are unencrypted plaintext form. For example, as shown in FIG. 3D, when selecting section 342 or 344 for processing by selecting the first content block in the respective section, e.g., P(1) or P(N+1), the memory device initializes its counter value to zero.

The memory device determines whether value of the counter is less than CNT_1 (710). For example, in some implementations using the encryption mechanism 300D, the memory device processes the content blocks in a selected section in the following sequence, incrementing the counter value by one after each content block is processed: a first subset of the content blocks (e.g., equal to the value of STD_CNT) is encrypted using a standard encryption algorithm, a second subset of the content blocks (e.g., equal to the value of SMP_CNT) is encrypted using a simplified encryption algorithm, while the remaining content blocks in the section are unencrypted (e.g., equal to SEC_CNT−(STD_CNT+SMP_CNT)). To illustrate, as an example, in some implementations of the mechanism 300D in FIG. 3D, STD_CNT=1 and SMP_CNT=1, which indicates that, in section 342, memory device 110 encrypts plaintext content block P(1) using standard encryption algorithm (e.g., STD_CNT=1) and encrypts plaintext content block P(2) using a simplified encryption algorithm (e.g., SMP_CNT=1), while remaining content blocks, such as P(N), are sent as unencrypted plaintext content blocks. Similarly, in section 344, the memory device 110 encrypts plaintext content blocks P(N+1) and P(N+2) using the standard and the simplified encryption algorithms, respectively, while content block P(2N) is sent as unencrypted plaintext content block. In such implementations, CNT_1==STD_CNT. Accordingly, in such implementations, when reading a selected content block in a selected section of the requested content, following the above sequence, the memory device 110 first checks whether all plaintext content blocks to be encrypted using standard encryption in the presently selected section have been processed, by comparing its counter value to STD_CNT.

In some implementations, standard and simplified encryption algorithms are used in a reverse order compared to the above. In such implementations, content blocks in each section are processed in the following sequence: a first subset of the content blocks (e.g., equal to the value of SMP_CNT) is encrypted or decrypted using a simplified encryption algorithm, a second subset of the content blocks (e.g., equal to the value of STD_CNT) is encrypted or decrypted using a standard encryption algorithm, while the remaining content blocks in the section are unencrypted. As an illustrative example, in some implementations of the mechanism 300D in FIG. 3D, SMP_CNT=1 and STD CNT=1. In such implementations, in section 342, memory device 110 encrypts plaintext content block P(1) using a simplified encryption algorithm (e.g., SMP_CNT=1) and encrypts plaintext content block P(2) using a standard encryption algorithm (e.g., STD_CNT=1), while remaining content blocks, such as P(N), are sent as unencrypted plaintext content blocks. Similarly, in section 344, the memory device 110 encrypts plaintext content blocks P(N+1) and P(N+2) using the simplified and the standard encryption algorithms, respectively, while content block P(2N) is sent as unencrypted plaintext content block. In such implementations, CNT_1==SMP_CNT. Accordingly, in such implementations, when reading a selected content block in a selected section of the requested content, following the above sequence, the memory device 110 first checks whether all plaintext content blocks to be encrypted using simplified encryption in the presently selected section have been processed, by comparing its counter value to SMP_CNT.

If the memory device determines that the value of the counter is less than CNT_1, then the memory device encrypts the presently selected plaintext content block in the presently selected section using a first encryption algorithm (712). For example, in implementations where CNT_1==STD_CNT, the first encryption algorithm is a standard encryption algorithm. In such implementations, when the counter value is less than STD_CNT, then the memory device 110 determines that not all plaintext content blocks in the first subset of content blocks in the present section, to be encrypted using the standard encryption algorithm, have been processed. Accordingly, for the presently selected plaintext content block of the section, the memory device 110 encrypts the plaintext using the standard encryption algorithm. For example, the memory device 110 encrypts plaintext content block P(1) in section 342 using the standard encryption algorithm to obtain the corresponding ciphertext content block C(1). Similarly, when processing section 344, the memory device 110 encrypts the plaintext content block P(N+1) using the standard encryption algorithm to obtain the corresponding ciphertext content block C(N+1).

As another example, in implementations where CNT_1==SMP_CNT, the first encryption algorithm is a simplified encryption algorithm. In such implementations, when the counter value is less than SMP_CNT, then the memory device 110 determines that not all plaintext content blocks in the first subset of content blocks in the present section, to be encrypted using the simplified encryption algorithm, have been processed. Accordingly, for the presently selected plaintext content block of the section, the memory device 110 encrypts the plaintext using the simplified encryption algorithm. For example, the memory device 110 encrypts plaintext content block P(1) in section 342 using the simplified encryption algorithm to obtain the corresponding ciphertext content block C(1). Similarly, when processing section 344, the memory device 110 encrypts the plaintext content block P(N+1) using the simplified encryption algorithm to obtain the corresponding ciphertext content block C(N+1).

On the other hand, if the memory device determines that the value of the counter is equal to or greater than CNT_1, then the memory device further checks whether value of the counter is less than CNT_1+CNT_2 (714). For example, in implementations where CNT_1==STD_CNT, CNT_2==SMP_CNT. In such implementations, when the first subset of content blocks in the section have been encrypted, such that the value of the counter is at least equal to STD_CNT, then the memory device 110 checks whether any content block in the second subset of content blocks in the section are remaining to be encrypted, e.g. using the simplified encryption algorithm, by comparing the total number of content blocks processed to STD_CNT+SMP_CNT. In implementations where CNT_1==SMP_CNT, CNT_2==STD_CNT. In such implementations, when the first subset of content blocks in the section have been encrypted, such that the value of the counter is at least equal to SMP_CNT, then the memory device 110 checks whether any content block in the second subset of content blocks in the section are remaining to be encrypted, e.g. using the standard encryption algorithm, by comparing the total number of content blocks processed to SMP_CNT+STD_CNT.

If the memory device determines that the value of the counter is less than CNT_1+CNT_2, then the memory device encrypts the plaintext content block using a second encryption algorithm (716). For example, in implementations where CNT)_1==STD_CNT and CNT_2==SMP_CNT, the second encryption algorithm is a simplified encryption algorithm (while the first encryption algorithm is a standard encryption algorithm, as noted above). In such implementations, when the counter value is greater than STD_CNT but less than STD_CNT+SMP_CNT, the memory device 110 determines that not all plaintext content blocks in the second subset of content blocks in the section have been processed. Accordingly, for the presently selected ciphertext content block of the section, the memory device 110 encrypts the plaintext content using the simplified encryption algorithm. For example, the memory device 110 encrypts plaintext content block P(2) in section 342 using the simplified encryption algorithm to obtain the corresponding ciphertext content block C(2). Similarly, when processing section 344, the memory device 110 encrypts the plaintext content block P(N+2) using the simplified encryption algorithm to obtain the corresponding ciphertext content block C(N+2). As another example, in implementations where CNT_1==SMP_CNT and CNT_2==STD_CNT, the second encryption algorithm is a standard encryption algorithm (while the first encryption algorithm is a simplified encryption algorithm, as noted above). In such implementations, when the counter value is greater than SMP_CNT but less than SMP_CNT+STD_CNT, the memory device 110 determines that not all plaintext content blocks in the second subset of content blocks in the section have been processed. Accordingly, for the presently selected ciphertext content block of the section, the memory device 110 encrypts the plaintext content using the standard encryption algorithm. For example, the memory device 110 encrypts plaintext content block P(2) in section 342 using the standard encryption algorithm to obtain the corresponding ciphertext content block C(2). Similarly, when processing section 344, the memory device 110 encrypts the plaintext content block P(N+2) using the standard encryption algorithm to obtain the corresponding ciphertext content block C(N+2).

On the other hand, if the memory device determines that the value of the counter is equal to or greater than CNT_1+CNT_2, then the memory device retains the plaintext content block in its unencrypted form (718). For example, when the first and second subsets of content blocks in the section have been processed, such that the value of the counter is at least equal to CNT_1+CNT_@, then the remaining content blocks in the section are not encrypted. Accordingly, the memory device 110 retains the plaintext content of these unencrypted content blocks without any further cryptographic operations. For example, the memory device 110 retains the plaintext content block P(N) in section 342 in unencrypted form. Similarly, when processing section 344, the memory device 110 retains the plaintext content block P(2N) in unencrypted form.

In some implementations, the memory device processes the requested content by encrypting a subset of content blocks in a section using a single encryption algorithm, e.g., using the encryption mechanism 300A or 300B. In such implementations, the operations (714) and (716) are not included in the process 700.

After processing each content block, e.g., after encrypting the selected content block using the first encryption algorithm (712) or the second encryption algorithm (716), or after retaining plaintext content from an unencrypted content block (718), the memory device checks whether complete plaintext content has been processed for the requested content (720). If the memory device determines that the complete plaintext content has not been processed, e.g., not all sections, or all content blocks in a section, have been processed, then the memory device increments the counter (722). For example, after processing each content block in a section, if the memory device 110 determines that there are additional content blocks remaining to be processed, either in the present section or in a new section, then the memory device increments its counter value and proceeds to select another content block in the present section, or a new section. For example, after processing content block P(1) in section 342, the memory device 110 determines that there are additional content blocks to be processed in the section, such as content blocks P(2) and P(N). The memory device then increments the counter and selects the next content block in the section, such as P(2).

The memory device determines whether value of the counter is equal to SEC_CNT (724). For example, the memory device 110 determines whether all the content blocks in the present section—the first and second subsets of plaintext content blocks and the remaining plaintext content blocks—have been processed, which is indicated by the value of the memory device counter being equal to SEC_CNT, e.g., the total number of content blocks in a section.

If the memory device determines that the value of the counter is not equal to SEC_CNT (724), then the memory device continues to process additional blocks in the presently selected section (710)-(718). For example, when not all content blocks in the presently selected section has been processed, either in the first subset of content blocks (710)-(712), or the second subset of content blocks (714)-(716), or the remaining plaintext content blocks (718), then the value of the memory device counter is less than SEC_CNT. Accordingly, the memory device 110 continues to process the remaining content blocks in the present section. For example, after processing content block P(2) in section 342, the memory device 110 determines that not all content blocks in the section 342 have been processed, and the counter value is less than SEC_CNT. The memory device 110 then selects the next content block in the section 342 for processing.

On the other hand, if the memory device determines that the value of the counter is equal to SEC_CNT (724), then the memory device selects a new section and initializes the counter value (708) to process the content blocks in the newly selected section, following the operations as described with respect to (708)-(720). For example, after processing content block P(N) in section 342, the memory device 110 determines that all content blocks in the section 342 have been processed, and the counter value is equal to SEC_CNT. The memory device 110 then resets its counter value to zero and processes the next section of requested content, e.g., section 344.

Reverting to (720), if the memory device determines that the all content blocks have been processed, e.g., all sections of the requested content have been processed, then the memory device sends the secured content with encrypted and unencrypted content blocks and the signature to the host device (726). For example, after processing all the content blocks in all the sections of the requested content as described above, the memory device 110 prepares the secured content to include the processed content blocks, such as C(1), C(2), . . . , P(N), C(N+1), C(N+2), . . . , P(2N), and the digital signature, e.g., CRC 202. The memory device 110 then sends the secured content to the host device 120, e.g., using the bus 118. Upon receiving the secured content, the host device 120 processes the secured content as described, e.g., with respect to process 400 or process 600.

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA or an ASIC (application specific integrated circuit).

Processors suitable for the execution of a computer program include, by way of example, both general and special purpose microprocessors, and any one or more processors of any kind of digital computer. Computer readable media suitable for storing computer program instructions and data can include all forms of nonvolatile memory, media and memory devices. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A method comprising:
receiving, at a host device, secure data from a memory device that is coupled to the host device, the secure data including a first content block and a second content block;
determining, by the host device, that the first content block is encrypted;
upon determining that the first content block is encrypted, decrypting, by the host device, the first content block to obtain corresponding first plaintext data;
determining, by the host device, that the second content block is unencrypted;
upon determining that the second content block is unencrypted, obtaining, by the host device from the second content block, corresponding second plaintext data;
determining, by the host device, whether reception of secure data from the memory device is completed;
upon determining that reception of secure data from the memory device is completed, obtaining, by the host device, a first signature from a signature block sent by the memory device in conjunction with the secure data;
computing, by the host device, a second signature on plaintext data obtained by the host device, the plaintext data including the first plaintext data and the second plaintext data;
comparing, by the host device, the first signature to the second signature; and
conditioned on determining, by the host device as a result of the comparing, that the first signature is equal to the second signature, accepting, by the host device, the plaintext data as legitimate.

2. The method of claim 1, further comprising:
conditioned on determining, by the host device as a result of the comparing, that the first signature is not equal to the second signature, discarding, by the host device, the plaintext data as compromised.

3. The method of claim 1, wherein determining that the first content block is encrypted comprises determining that the first content block is encrypted using a first encryption mechanism, and wherein decrypting the first content block comprises decrypting the first content block using the first encryption mechanism.

4. The method of claim 3, further comprising:
receiving, at the host device, a third content block of the secure data from the memory device;
determining, by the host device, that the third content block is encrypted using a second encryption mechanism that is different from the first encryption mechanism; and
upon determining that the third content block is encrypted using the second encryption mechanism, decrypting, by the host device, the third content block using the second encryption mechanism to obtain third plaintext data,
wherein the second signature is computed on plaintext data that includes the first plaintext data, the second plaintext data and the third plaintext data.

5. The method of claim 4, wherein the host device receives the secure data from the memory device in a plurality of sections that each includes encrypted content blocks and unencrypted content blocks, wherein the host device includes a counter to count a number of content blocks of the secure data that is received, wherein
determining that the first content block is encrypted using the first encryption mechanism comprises determining that a value of the counter is less than a first threshold value that corresponds to a number of content blocks in a section encrypted using the first encryption mechanism,
determining that the third content block is encrypted using the second encryption mechanism comprises determining that the value of the counter is greater than the first threshold value but less than a second threshold value that corresponds to a number of content blocks in a section encrypted using the first encryption mechanism and the second encryption mechanism, and
determining that the second content block is unencrypted comprises determining that the value of the counter is greater than the second threshold value but less than a third threshold value that corresponds to a total number of content blocks in a section.

6. The method of claim 5, further comprising:
upon determining that reception of secure data from the memory device is not completed, incrementing the counter;
determining whether the counter is equal to the third threshold value;
conditioned on determining that the counter is equal to the third threshold value, resetting the counter to process a new section of the secure data received from the memory device; and
conditioned on determining that the counter is not equal to the third threshold value, processing one or more additional content blocks of the current section, the one or more additional content blocks including at least one of a content block encrypted using the first encryption mechanism, a content block encrypted using the second encryption mechanism, or an unencrypted content block.

7. The method of claim 5, wherein one or more of the first threshold value, the second threshold value or the third threshold value are configurable by a user, and wherein one or more of the first threshold value, the second threshold value or the third threshold value are stored in registers coupled to the memory device.

8. The method of claim 4, wherein the secure data received from the memory device includes a plurality of encrypted content blocks and unencrypted content blocks, wherein the host device receives additional information with the memory device about at least one of a relative arrangement of the encrypted content blocks and unencrypted content blocks in the secure data, the first encryption mechanism, or the second encryption mechanism, wherein
determining that the first content block is encrypted using the first encryption mechanism comprises analyzing the additional information received from the memory device to determine at least one of the first content block is encrypted or the first encryption mechanism is used to encrypt the first content block,
determining that the third content block is encrypted using the second encryption mechanism comprises analyzing the additional information received from the memory device to determine at least one of the third content block is encrypted or the second encryption mechanism is used to encrypt the third content block, and
determining that the second content block is unencrypted comprises analyzing the additional information received from the memory device to determine that the second content block is unencrypted.

9. The method of claim 1, wherein decrypting the first content block to obtain corresponding first plaintext data comprises:
upon decrypting the first content block, identifying a nonce value included in the first content block; and
removing the nonce value from the decrypted first content block to obtain the first plaintext data,
wherein the nonce value is synchronized between the host device and the memory device.

10. A method comprising:
receiving, at a memory device, a request for data from a host device that is coupled to the memory device;
in response to the request, processing, by the memory device, the data for transmission to the host device, wherein the processing comprises:
dividing the data into a plurality of sections, each section including one or more content blocks;
computing a signature on the content blocks included in the plurality of sections;
encrypting, in each section, a subset of the content blocks included in the section; and
including, in each section, a remaining number of unencrypted content blocks as plaintext; and
sending, to the host device, the plurality of sections along with the signature, each of the plurality of sections including encrypted content blocks and unencrypted content blocks.

11. The method of claim 10, wherein the memory device includes a counter to count a number of content blocks in each section, and wherein encrypting the subset of the content blocks in each section comprises:
determining whether a value of the counter is less than a first threshold value that corresponds to a number of content blocks in a section encrypted using a first encryption mechanism; and
upon determining that the value of the counter is less than the first threshold value, iteratively encrypting first content blocks of the subset of the content blocks using the first encryption mechanism, and incrementing the counter.

12. The method of claim 11, further comprising:
determining whether the value of the counter is less than a second threshold value that corresponds to a number of content blocks in a section encrypted using a second encryption mechanism that is different from the first encryption mechanism;
upon determining that the value of the counter is less than the second threshold value, iteratively encrypting second content blocks of the subset of the content blocks using the second encryption mechanism, and incrementing the counter;
determining that the value of the counter is equal to a third threshold value that corresponds to a total number of content blocks in a section; and
upon determining that the value of the counter is equal to the third threshold value, resetting the counter and processing a next section of the plurality of sections.

13. The method of claim 12, further comprising:
receiving, from the host device, one or more of the first threshold value, the second threshold value or the third threshold value that are configured by a user; and
storing one or more of the first threshold value, the second threshold value or the third threshold value in registers coupled to the memory device.

14. The method of claim 10, wherein encrypting the subset of the content blocks in each section comprises:
including, in one or more content blocks of the subset of the content blocks, a nonce value; and
encrypting the subset of the content blocks following including the nonce value in the one or more content blocks of the subset of the content blocks,
wherein the nonce value is synchronized with the host device.

15. A memory device comprising:
a storage memory for storing data;
a memory controller for managing access to the storage memory, wherein the memory controller is adapted to perform operations comprising:
receiving a request for data from a host device that is coupled to the memory device;
in response to the request, processing the requested data for transmission to the host device, wherein the processing comprises:
accessing, from the storage memory, the requested data;
dividing the requested data into a plurality of sections, each section including one or more content blocks;
computing a signature on the content blocks included in the plurality of sections;
encrypting, in each section, a subset of the content blocks included in the section; and
including, in each section, a remaining number of unencrypted content blocks as plaintext; and
sending, to the host device, the plurality of sections along with the signature, each of the plurality of sections including encrypted content blocks and unencrypted content blocks.

16. The memory device of claim 15, wherein the memory controller includes a counter to count a number of content blocks in each section, and wherein encrypting the subset of the content blocks in each section comprises:
determining whether a value of the counter is less than a first threshold value that corresponds to a number of content blocks in a section encrypted using a first encryption mechanism; and
upon determining that the value of the counter is less than the first threshold value, iteratively encrypting first content blocks of the subset of the content blocks using the first encryption mechanism, and incrementing the counter.

17. The memory device of claim 16, wherein the operations further comprise:
determining whether the value of the counter is less than a second threshold value that corresponds to a number of content blocks in a section encrypted using a second encryption mechanism that is different from the first encryption mechanism;
upon determining that the value of the counter is less than the second threshold value, iteratively encrypting second content blocks of the subset of the content blocks using the second encryption mechanism, and incrementing the counter;
determining that the value of the counter is equal to a third threshold value that corresponds to a total number of content blocks in a section; and
upon determining that the value of the counter is equal to the third threshold value, resetting the counter and processing a next section of the plurality of sections.

18. The memory device of claim 17, wherein the operations further comprise:
receiving, from the host device, one or more of the first threshold value, the second threshold value or the third threshold value that are configured by a user; and
storing one or more of the first threshold value, the second threshold value or the third threshold value in registers coupled to the memory controller.

19. The memory device of claim 15, wherein encrypting the subset of the content blocks in each section comprises:
including, in one or more content blocks of the subset of the content blocks, a nonce value; and
encrypting the subset of the content blocks following including the nonce value in the one or more content blocks of the subset of the content blocks,
wherein the nonce value is synchronized with the host device.

20. The memory device of claim 15, wherein encrypting the subset of the content blocks in each section comprises selecting one or more first content blocks of the subset and encrypting the one or more first content blocks using a first encryption mechanism, and
wherein the operations further comprise sending, to the host device, additional information that includes at least one of location information of the one or more first content blocks, or the first encryption mechanism.

21. The memory device of claim 15, wherein encrypting the subset of the content blocks in each section comprises:
selecting one or more first content blocks and one or more second content blocks of the subset;
encrypting the one or more first content blocks using a first encryption mechanism; and
encrypting the one or more first content blocks using a second encryption mechanism.

22. The memory device of claim 21, wherein the operations further comprise:
sending, to the host device, additional information that includes at least one of location information of the one or more first content blocks, location information of the one or more second content blocks, the first encryption mechanism or the second encryption mechanism.
